(19) United States
(12) Patent Application Publication
(10) Pub. No.: US 2020/0395583 A1
(43) Pub. Date: Dec. 17, 2020

(54) SEPARATOR FOR ELECTROCHEMICAL CELLS AND METHOD OF MAKING THE SAME

(71) Applicant: OPTODOT CORPORATION, Devens, MA (US)

(72) Inventors: Steven A. Carlson, Cambridge, MA (US); David W. Avison, Boxborough, MA (US); Benjamin Sloan, Exeter, NH (US)

(21) Appl. No.: 16/754,487

(22) PCT Filed: Oct. 9, 2018
(86) PCT No.: PCT/US2018/055014

§ 371 Date: Apr. 8, 2020

Related U.S. Application Data
(60) Provisional application No. 62/569,964, filed on Oct. 9, 2017.

(51) Int. Cl. H01M 2/16; H01M 10/0525; H01M 10/0569; H01M 2/14; H01M 2/34

(52) U.S. Cl. CPC H01M 2/166; H01M 2/1686; H01M 2/1646; H01M 2/1653; H01M 2300/0028; H01M 10/0569; H01M 2/145; H01M 2/348; H01M 10/0525

(57) ABSTRACT

A separator for an electrochemical cell having a porous layer with a blend of a first type of boehmite particles and a second type of boehmite particles and an organic polymer binder, where the first type of boehmite particles is different from the second type of boehmite particles with respect to crystallite particle size and/or composition, and the blend ranges from about 50%-50% by weight of the first and second types of boehmite particles to about 60%-40% by weight of the first and second types of boehmite particles. The separator does not include a polymer separator layer; has a shrinkage of less than 1% when heated at 220° C. for 1 hour; and swells by less than 5% when soaked in propylene carbonate for 1 hour.

### CROSS-REFERENCE TO RELATED APPLICATIONS

This application claims the benefit of and priority to U.S. Provisional Patent Application No. 62/569,964, filed on Oct. 9, 2017, the entire contents of which are incorporated by reference herein.

### STATEMENT REGARDING FEDERALLY SPONSORED RESEARCH OR DEVELOPMENT

This invention was made with government support under W56HZV-13-C-0063 awarded by the Department of Defense. The government has certain rights in the invention.

### FIELD OF THE INVENTION

The present invention relates to separators for use in electrochemical cells, such as rechargeable lithium ion batteries, and methods for manufacturing the separators and electrochemical cells incorporating the separators.

### BACKGROUND OF THE INVENTION

Continued improvements in electrical energy storage by using rechargeable lithium ion batteries are of particular interest in a wide range of applications—for example, personal electronic devices, electric automobiles, home energy storage, renewable power generation storage, and the like. For portable devices, there is particular interest in improved high temperature operational stability, miniaturization, ease of manufacture, etc. In particular, separators between anodes and cathodes are key elements in lithium ion batteries for use in electronic devices. Such separators have traditionally been made with a ceramic material being disposed on either or both sides of a sheet of a porous polymer substrate material, so-called ceramic-coated plastic separators (CCS), and placed between the electrodes. One of a number of considerations for the material used in a separator is tolerance for high temperatures while the battery is in use and plastic materials tend not to be suitable for very high temperatures. As lithium ion batteries have incorporated less safe, higher energy density electrode materials into more energy dense batteries of increasing sizes, such as 40 Ah to 100 Ah lithium ion cells in battery packs of many cells, ceramic-coated plastic separators (CCS) do not provide the enhanced safety needed, such as in the nail penetration test of a forced short circuit on the battery. The heat shrinkage of the plastic polymer support material of CCS at temperatures starting around 110° C. also limits the ability to vacuum dry the CCS and stacks of the CCS and the electrodes in order to remove any residual water and other volatiles prior to filling the dry lithium ion cell with electrolyte. Also, the plastic polymer support material is a thermal insulator and does not have the thermal conductivity to efficiently spread the heat to provide more safety when a sudden heating event occurs in the cell.

Techniques on forming free-standing all-ceramic separators (CSP) for use in electrochemical cells have been developed in light of the above-described issues related to polymer substrates, for example, as described in U.S. Patent Application Publication Nos. 2013/0171500 to Xu et al. and 2015/0030933 to Goetzen et al. One challenge with previous CSPs is obtaining sufficient mechanical strength for cell assembly without any breakage of the separator and for withstanding the mechanical stresses of the cell cycling, while providing the high % porosity of the separator needed for acceptable ionic conductivity and not showing any incompatibility and degradation with the battery cell chemistry. The requirement for mechanical strength of the separator has significantly increased in recent years due to the large increase in the cell assembly speeds in order to lower the cost of the batteries. Besides mechanical strength in the separator, it is also important that the separator have a high modulus up to 2% elongation to avoid stretching during cell assembly and a high level of flexibility to withstand the bending and any folding during cell assembly.

### SUMMARY OF THE INVENTION

In view of the foregoing, it is an objective of the present invention to provide an improved free-standing, and substantially all-ceramic, composite separator (CSP), without a porous polymer substrate, that is suitable for use in an electrochemical cell, such as a lithium ion cell.

In an exemplary embodiment of the invention, an electrochemical cell incorporating one or more porous inorganic/organic composite separator layers reaches a peak temperature at or below 100° C. in a nail penetration test conducted with a 3 mm diameter nail penetrating at approximately 80 mm/s.

In an exemplary embodiment, an electrochemical cell incorporating one or more inorganic/organic composite separator layers maintains operation at or below 150° C. over a period of at least 3 hours, preferably at or below 200° C. over a period of at least 2 hours, and more preferably at or below 100° C. over a period of at least 30 hours (when heated to those temperatures over those time periods in an accelerating rate calorimeter (ARC) test).

In an exemplary embodiment, a composite separator comprises one or more porous inorganic/organic composite separator layers with an overall thickness at or below 20 microns, preferably at or below 15 microns, and more preferably at or below 12 microns.

In an exemplary embodiment, a composite separator comprises one or more porous inorganic/organic composite separator layers, which composite separator swells by or below 5% after soaking for 1 hour in a non-aqueous electrolyte or in propylene carbonate, preferably by or below 3%.

In an exemplary embodiment, a composite separator comprises one or more porous inorganic/organic composite separator layers, which composite separator has an overall resistance at or below 1.5 ohms, preferably at or below 1.4 ohms, and more preferably below 1.0 ohm.

In an exemplary embodiment, a composite separator comprises one or more porous inorganic/organic composite separator layers, which composite separator has a maximum tensile stress of, at least, approximately 1700 psi, a maximum tensile load of, at least, approximately 0.5 kg, and a percentage elongation at break of, at least, approximately fifteen (15) percent (%).

In an exemplary embodiment, a composite separator is made by coating one or more composite separator layers in a predetermined order on a release substrate, delaminating the layers from the release substrate, and vacuum drying the delaminated layers at approximately 130° C.-150° C. for approximately 1 hour-4 hours to provide a free-standing composite separator.

In an exemplary embodiment, a multi-layer composite separator comprises a porous layer comprising particles and a polymer that is non-swelling in a non-aqueous electrolyte, and a porous inorganic/organic composite separator layer on one or both sides of the porous layer, wherein the composite separator layer comprises a polymer that swells in the non-aqueous electrolyte.

In an exemplary embodiment, the particles comprise inorganic particles selected from the group consisting of inorganic oxides and inorganic nitrides.

In an exemplary embodiment, the inorganic particles comprise boehmite particles.

In an exemplary embodiment, the particles comprise polymer particles that are insoluble in water.

In an exemplary embodiment, the particles comprise polymer particles that are insoluble in propylene carbonate.

In an exemplary embodiment, the porous layer comprises a crosslinking agent that reacts with said polymer particles.

In an exemplary embodiment, the particles comprise inorganic particles selected from the group consisting of inorganic oxides and inorganic nitrides and further comprise polymer particles that are insoluble in water.

In an exemplary embodiment, the polymer in said porous layer is a polyvinyl alcohol.

In an exemplary embodiment, the polymer in said composite separator layer is a polyvinylidene difluoride (PVdF).

In an exemplary embodiment, the composite separator layer comprises inorganic particles selected from the group consisting of inorganic oxides and inorganic nitrides.

In an exemplary embodiment, the inorganic particles comprise boehmite particles.

In an exemplary embodiment, the weight percent of inorganic particles in said composite separator layer is 60% to 95%.

In an exemplary embodiment, the composite separator layer is a xerogel layer.

In an exemplary embodiment, the porous layer is a safety shutdown layer.

In an exemplary embodiment, the multi-layer composite separator swells by or below 0.5% after soaking in electrolyte for 1 hour.

In an exemplary embodiment, a multilayer separator is made by coating a porous layer and one or more composite separator layers in a predetermined order on a release substrate, and delaminating the layers from the release substrate to provide a free-standing multilayer composite separator.

In an exemplary embodiment, each layer is provided by a coating step.

In an exemplary embodiment, a lamination step is performed after one or more coating steps.

In an exemplary embodiment, the multi-layer separator is compressed in thickness in narrow lanes prior to slitting in the lanes to provide the desired width and to increase the mechanical strength along the edges of the multi-layer separator.

In an exemplary embodiment, a multi-layer composite separator comprises a porous layer comprising a polymer that is non-swelling in a non-aqueous electrolyte, the porous layer being formed by a phase inversion method, and a porous inorganic/organic composite separator layer on one or both sides of said porous layer, the composite separator layer comprising a polymer that swells in the non-aqueous electrolyte.

Other features and advantages of the present invention will become readily apparent from the following detailed description and the accompanying drawings.

### BRIEF DESCRIPTION OF THE DRAWINGS

The above and related objects, features and advantages of the present invention will be more fully understood by reference to the following, detailed description of the preferred, albeit illustrative, embodiments of the present invention when taken in conjunction with the accompanying figures, wherein:

FIG. 1A is a flow diagram showing a binder solution preparation process according to an exemplary embodiment of the invention;

FIG. 1B is a flow diagram showing a ceramic dispersion preparation process according to an exemplary embodiment of the invention:

FIG. 1C is a flow diagram showing a separator coating mix preparation process according to an exemplary embodiment of the invention;

FIG. 2 is a plan view of a mixing chamber in accordance with an exemplary embodiment of the invention;

FIGS. 3A and 3B are graphs reflecting the viscosity and particle size distribution, respectively, of the ceramic separator coating mixture material resulting from process 100c illustrated in FIG. 1C;

FIGS. 3C, 3D, 3E, 3F, and 3G are cross-sectional side view micrographs (by scanning electron microscope, “SEM”) of a CSP formed in accordance with an exemplary embodiment of the invention;

FIG. 3H is a graph showing comparative pore size distributions of coated and dried CSPs formed in accordance with exemplary embodiments of the invention;

FIG. 4 is a representative diagram of an assembly for producing a free-standing all-ceramic separator according to an exemplary embodiment of the present invention;

FIG. 5 is a cross sectional view of a shutdown layer disposed on a composite separator layer in accordance with an exemplary embodiment of the present invention;

FIGS. 6A, 6B, 6C, and 6D are graph plots reflecting the “Time vs. Temperature” and “Self-Heating vs. Temperature” results, respectively, in Accelerating Rate Calorimeter (ARC) testing for electrochemical cell samples incorporating separators made in accordance with an exemplary embodiment of the invention;

FIGS. 7A, 7B, 7C, and 7D are graph plots reflecting the “Time vs. Temperature” and “Self-Heating vs. Temperature” results, respectively, in the ARC testing for another set of electrochemical cell samples incorporating separators made in accordance with an exemplary embodiment of the invention;

FIGS. 8A, 8B, 8C, and 8D are graph plots reflecting the “Time vs. Temperature” and “Self-Heating vs. Temperature” results, respectively, in the ARC testing for electrochemical cell samples incorporating separators made in accordance with another embodiment of the invention;

FIGS. 9A, 9B, 9C, and 9D are graph plots reflecting the “Time vs. Temperature” and “Self-Heating vs. Temperature” results, respectively, in the ARC testing for comparative electrochemical cell samples;

FIGS. 10A, 10B, 10C, and 10D are graph plots reflecting the “Time vs. Temperature” and “Self-Heating vs. Temperature” results, respectively, in the ARC testing for another set of electrochemical cell samples incorporating separators made in accordance with yet another embodiment of the invention;

FIGS. 11A, 11B, 11C, and 11D are graph plots reflecting the “Time vs. Temperature” and “Self-Heating vs. Temperature” results, respectively, in the ARC testing for comparative electrochemical cell samples;

FIGS. 12A, 12B, 12C, and 12D are graph plots reflecting the “Time vs. Temperature” and “Self-Heating vs. Temperature” results, respectively, in the ARC testing for control electrochemical cell samples;

FIGS. 13A, 13B, 13C, and 13D are graph plots reflecting the “Time vs. Temperature” and “Self-Heating vs. Temperature” results, respectively, in the ARC testing for control electrochemical cell samples;

FIGS. 14A and 14B are selective plots of Sudden Heating Events before complete cell failure for electrochemical cell samples incorporating separators made in accordance with an exemplary embodiment of the invention and comparative samples, respectively;

FIG. 15 is a graph showing thermal conductivity results of separator samples made in accordance with an exemplary embodiment of the invention and comparative separator samples;

FIGS. 16A and 16B are graph plots on Temperature and Voltage over the duration of a nail penetration test for control cell samples and CSP cell samples made in accordance with an exemplary embodiment of the invention;

FIGS. 16C and 16D are graph plots on Temperature over Time in a nail penetration test for control cell samples and CSP cell samples made in accordance with an exemplary embodiment of the invention;

FIGS. 17A and 17B are graph plots of Life Cycle testing results for control cell samples and cells incorporating various CSP dimensions made in accordance with an exemplary embodiment of the invention;

FIGS. 18A, 18B, 18C, and 18D are graph plots of cycling rate capability testing results for control cell samples and cells incorporating various CSP dimensions made in accordance with an exemplary embodiment of the invention;

FIGS. 19A and 19B are graph plots of 28-day discharge capacity retention and voltage drop testing results, respectively, for control cell samples and cells incorporating CSP separators made in accordance with an exemplary embodiment of the invention;

FIGS. 20A and 20B are graph plots of 1-year discharge capacity retention and voltage drop testing results, respectively, for control cell samples and cells incorporating CSP separators made in accordance with an exemplary embodiment of the invention;

FIGS. 21A, 21B, and 21C are graph plots of discharge resistance testing results for control cell samples and cells incorporating CSP separators made in accordance with an exemplary embodiment of the invention;

FIG. 22 is a graph plot of testing results of heat induced dimensional changes found in control separator samples and separator samples made in accordance with an exemplary embodiment of the invention;

FIGS. 23A, 23B, 23C, 23D, and 23E are graph plots of life cycle testing results on cells incorporating separators made in accordance with embodiments of the invention with various drying processes;

FIG. 24 is a graph plot of cycling rate capability comparisons of cells incorporating separators made in accordance with embodiments of the invention;

FIG. 25 is a graph plot of cell voltage comparisons during pulse power testing of cells incorporating separators made in accordance with embodiments of the invention;

FIGS. 26A, 26B, 26C, 26D, 26E, and 26F are graph plots of testing results on mechanical properties of separators made in accordance with embodiments of the invention before and after drying processes:

FIGS. 27A, 27B, 27C, 27D, and 27E are graph plots of testing results on mechanical properties of control separators and separators made in accordance with embodiments of the invention after calendering processes;

FIGS. 28A, 28B, 28C, and 28D are graph plots of testing results on mechanical properties of cross-linker coated separator samples made in accordance with embodiments of the invention;

FIGS. 29A, 29B, and 29C are graph plots of testing results on mechanical properties of separator samples made in accordance with embodiments of the invention with particular cross-linker coating parameters;

FIGS. 30A, 30B, and 30C are graph plots of testing results on mechanical properties of separator samples made in accordance with embodiments of the invention with a particular cross-linker coating;

FIGS. 31A, 31B, 31C, 31D, 31E, 31F, and 31G are graph plots of testing results on mechanical properties of separator samples made in accordance with embodiments of the invention with edge reinforcement coating;

FIG. 32A illustrates a cross-sectional view of a layer structure among a non-swelling porous layer and CSP layers in accordance with an exemplary embodiment of the invention;

FIG. 32B is a graph of test results showing the relationship between the Gurley air permeability of laminate samples and the weight fractions of the non-swelling layer blends in accordance with embodiments of the invention;

FIG. 32C is a graph of test results showing the relationship between the percentage (%) swelling of laminate samples and the weight fractions of the non-swelling layer blends in accordance with embodiments of the invention

FIGS. 33A-33E are illustrations of test results on tensile stress, elongation, Gurley air permeability, impedance, and % swelling in propylene carbonate on CSP separator samples made in accordance with embodiments of the invention; and

FIGS. 34A-34F are illustrations of test results on CSP separator samples made in accordance with embodiments of the invention before and after an extraction process.

### DETAILED DESCRIPTION

Reference will now be made in detail to the example embodiment(s), as illustrated in the accompanying drawings. Whenever possible, the same reference numerals will be used throughout the drawings to refer to the same or like parts.

The term “substrate” refers to any supporting structure including, but not limited to, a thin sheet of porous polymeric material or polymer separator layer, such as a porous polyolefin substrate or layer as used to manufacture ceramic-coated separators (CCS) or a porous non-woven polymer substrate or layer as used to manufacture ceramic-coated and impregnated separators. The term “substrate” also refers to the thick but flexible sheet of a plastic release film used in the methods of manufacturing embodiments of the invention.

A free-standing composite separator without an attached substrate, or an all-ceramic separator (CSP), for use in an electrochemical cell is desirable for ease of manufacture and cell fabrication, and for high temperature performance in comparison to conventional CCS comprising polymer substrates. The present invention is directed to techniques for forming a separator comprised substantially of ceramic material that is applicable as a free-standing element positioned between electrodes in an electrochemical cell. The present invention is also directed to the CSP itself, including its chemical composition, formulation, physical properties and performance properties.

I. Coating Mix Process

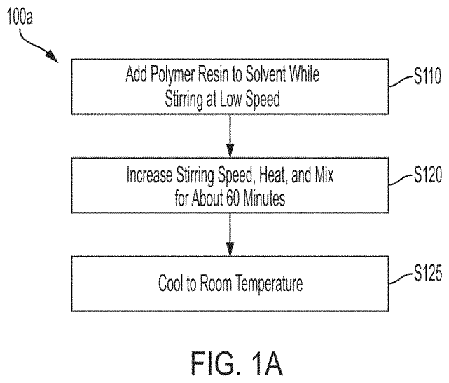

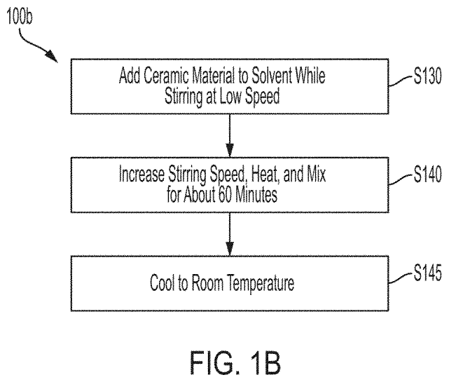

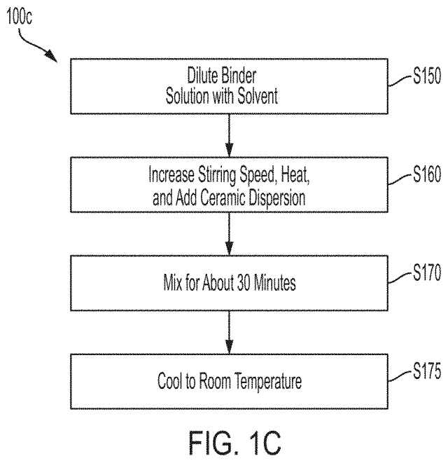

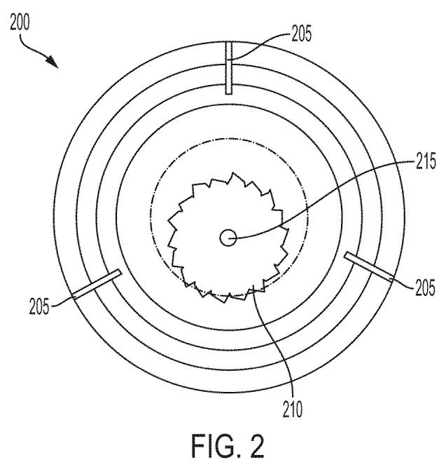

A process for forming separator material according to an exemplary embodiment of the present invention is shown in FIGS. 1A, 1B, and 1C. First, FIG. 1A is a flow diagram showing a binder solution preparation process 100a according to an exemplary embodiment of the invention. Referring to FIG. 1A, at step S110, a polymer resin, such as polyvinylidene fluoride (PVdF)(e.g., Solef® 5130 available from Solvay Specialty Polymers), is added to a solvent, such as N-methyl-2-pyrrolidone (NMP), while stirring at a low speed in a mixing chamber. According to a preferred embodiment, the solvent is substantially all NMP for facilitating dissolution and improved final coating rheology of the separator material. FIG. 2 illustrates a mixing chamber 200 in plan view in accordance with an exemplary embodiment of the invention. As shown in FIG. 2, mixing chamber 200 may be a cylindrical pail that includes one or more baffles 205 disposed along its circumferential inner wall for facilitating dissolution of the resin in process step S110. In accordance with an exemplary embodiment of the invention, mixing chamber 200 is fitted with an anti-static liner (not shown) on its inner wall. The stirring may be performed by a Cowles blade 210, and the like, mounted to a stir shaft 215. For a 10 kg scale of the binder preparation, the mixing chamber may have a 5 gallon capacity and is fitted with a 4″ Cowles blade 210. Correspondingly, 900 g of PVdF resin may be added to 9.1 kg of NMP at step S110.

At step S120 in FIG. 1A, after the PVdF resin is added, the stirring speed of stir shaft 215 is increased—to 2650 RPM—and the mixture is stirred for approximately 60 minutes. According to a preferred embodiment, the mixture is stirred at an elevated temperature—for example, between approximately 40-60° C. to facilitate full solubilization of the PVdF binder and to minimize the possibility of the mixture retaining any partially soluble gels. Additionally, a preferred embodiment of the invention utilizes the Cowles blade 210 to increase shear and to, thereby, enhance solubilization. In particular, the PVdF polymer, which has a very high molecular weight at about 1,000,000 Daltons and is at a very high viscosity because of the high % solids of 9%, requires vigorous stirring to completely dissolve. After the stirring, at step S125, the mixture is cooled to room temperature.

FIG. 1B is a flow diagram showing a ceramic dispersion preparation process 100b according to an exemplary embodiment of the invention. In a preferred embodiment of the invention, boehmite is used as a principal ceramic material for forming the separator. Referring to FIG. 1B, at step S130, a ceramic material, such as boehmite particles (e.g., in a powder form), is added to a solvent, such as NMP, while stirring at a low speed (e.g., 500 rpm) in a mixing chamber—for example, mixing chamber 200 shown in FIG. 2. In a preferred embodiment, the solvent is substantially all NMP for improved final coating rheology and finer dispersions of a preferred blend of boehmites. Additionally, two or more different grades of boehmite material may be added at step S130 in a predetermined order at respective proportions, rates, and durations. In a preferred embodiment, a hydrophobically-modified grade of boehmite is added first at step S130. For a 10 kg scale of the ceramic dispersion preparation in correspondence with the binder preparation illustrated in FIG. 1A, 5 kg of boehmite may be added to 5 kg of NMP in step S130.

At step S140, after the boehmite is added, the stirring speed of stir shaft 215 is increased—to 2650 RPM—and the mixture is stirred for approximately 60 minutes. According to a preferred embodiment, the mixture is stirred at an elevated temperature—for example, between approximately 40-60° C. to facilitate full dispersion. After the stirring, at step S145, the mixture is cooled to room temperature.

Referring now to FIG. 1C, a process 100c of mixing the binder solution and the ceramic dispersion formed in processes 100a and 100b, shown in FIGS. 1A and 1B, respectively, to form the separator material (coating mix) will be described. As shown in FIG. 1C, at step S150, a binder solution—for example, the binder solution formed by process 100a shown in FIG. 1A—is diluted with a solvent, such as NMP, while gently stirring in a mixing chamber, such as mixing chamber 200 shown in FIG. 2. According to a preferred embodiment, the solvent is substantially all NMP for facilitating dissolution and improved final coating rheology of the separator material. For a 10 kg scale, approximately 4444 g of the binder solution (9% non-volatiles or NV) may be diluted with approximately 2756 g of NMP at step S150.

At step S160, after the binder solution is diluted, the stirring speed of stir shaft 215 is increased—to 1000 RPM—and the ceramic dispersion—for example, the boehmite dispersion formed by process 100b shown in FIG. 1B—is added. At step S170, stirring speed is maintained at 1000 RPM, or if necessary, adjusted to ensure fluid turnover while minimizing air entrainment over approximately 30 minutes. According to a preferred embodiment, the mixture is stirred at an elevated temperature—for example, between approximately 40-60° C. to facilitate full homogeneous mixing. For a 10 kg scale, approximately 2.8 kg of the boehmite dispersion (50% NV) may be added at step S160. In a preferred embodiment, a Cowles blade 210 is used in mixing chamber 200 for stirring the mixture with increased mixing and shear in order to prevent irreversible agglomeration of boehmite particles, which may yield a larger/broader final particle size distribution. After the stirring, at step S175, the mixture is cooled to room temperature.

According to an exemplary embodiment of the invention, the coating mixture for manufacturing a CSP separator may be formed by the processes 100a-100c, as shown in FIGS. 1A-1C, with varying proportions of respective grades of ceramic material and binder material.

### Example 1

As examples, four particular types of CSP separators with specified approximate material proportions have been made with satisfactory testing results, shown in Table 1 below.

TABLE 1

| | | | | Pigment:Binder |
|---|---|---|---|---|
| Separator | | | | (Boehmite:PVdF) |
| Version | Boehmite 1 | Boehmite 2 | PVdF | (P:B) |
| CSP-A | Sasol Dispal ® | Sasol Dispal ® | Solef ® | 3.5:1 |
| | 10F4 (50%) | 10SR (50%) | 5130 | |
| CSP-B | Sasol (D60) | Sasol Dispal ® | Solef ® | 3.5:1 |
| | Disperal ® 60 | 10SR (50%) | 5130 | |
| | (50%) | | | |
| CSP-B2 | Sasol (D60) | Sasol Dispal ® | Solef ® | 3.75:1 |
| | Disperal ® 60 | 10SR (40%) | 5140 | |
| | (60%) | | | |
| CSP-B3 | Sasol (D60) | Sasol Dispal ® | Solef ® | 4.25:1 |
| | Disperal ® 60 | 10SR (40%) | 5140 | |
| | (60%) | | | |

Properties of boehmite pigments from Sasol, Lake Charles, La., and Duren, Germany, are summarized below:

| | Sasol | Sasol | Sasol |
|---|---|---|---|
| Chemical and | Dispal ® | Disperal ® | Dispal ® |
| Physical Properties | 10F4 | 60 | 10SR |
| Al2O3 (%) | 83 | 80 | 78 |
| H3COO— (%) | 0.25 | — | — |
| Loose Bulk Density | 550 | 300-500 | — |
| (g/l) | | | |
| Particle Size (d50) | 30 | 35 | 30 |
| (μm) | | | |
| Surface Area (BET)* | 100 | 95 | 100 |
| (m2/g) | | | |
| Pore Volume* (ml/g) | 0.8 | 0.9 | 0.8 |
| Crystallite size | 40 | 60 | 40 |
| (120) (nm) | | | |
| Dispersed Particle | 240 | below | N/A |
| Size (nm) | | | |
| Measured with PCS | | 350 | |
| Measured with Disc | | 250 | |
| Centrifuge | | | |
| Surface Treatment | — | — | p-toluene |
| | | | sulfonic |
| | | | acid |

*Activation at 550 C. for 3 hours.

In this and following Examples on testing performed on CSP-A, CSP-B, CSP-B2, and CSP-B3 separators, the 10F4 Boehmite is surface-treated with formic acid and the 10SR Boehmite is surface-treated with p-toluene sulfonic acid (p-TSA). The surface treatment of boehmite particles with formic acid makes the boehmite more dispersible in water and in protic solvents, such as alcohols, but does not enable dispersion in NMP, which is one of several aprotic solvents that are capable of fully dissolving PVdF at a 3% by weight and higher solids content. As used herein, the terms “insoluble” and “not soluble” mean that less than 3% by weight of the material dissolved or was soluble at room temperature, or 25° C., in the particular solvent or water. The surface treatment of boehmite particles with p-toluene sulfonic acid enables dispersion in NMP. One of ordinary skill in the art would appreciate, based on the description herein, that material proportions, surface treatment of respective particles, and the like, may be altered without departing from the spirit and scope of the invention. Inorganic particles, such as boehmite, of different types, which may or may not be surface treated, may be blended at different proportions to form a CSP separator layer. For example, the ratio of Boehmite 1 to Boehmite 2 may be increased from 60%-40% by weight, as in CSP-B2 and CSP-B3, up to and including 75%-25% by weight. This increased ratio of Boehmite 1 to Boehmite 2 may be accompanied by a corresponding increase in P:B ratio. Other blends of inorganic particles may be similarly adjusted along with P:B ratio to maintain or increase mechanical strength and to lower swelling in organic carbonate solvents and in electrolytes while maintaining or increasing porosity and rate capability of the resulting separator.

II. Mixture Filtration

Given the high filler loading, optimization of boehmite particle size distribution, and blend ratios of surface-treated/“un-treated” (e.g., 10SR/10F4 or 10SR/D60 described above) boehmites, this inevitably yields small quantities of large (>10 micron) aggregates that must be removed for optimal separator performance. According to an exemplary embodiment, suitable filtration of the coating mixture is conducted prior to a die coating process, with a filter pore size of approximately 10 to 25 microns.

### Example 2

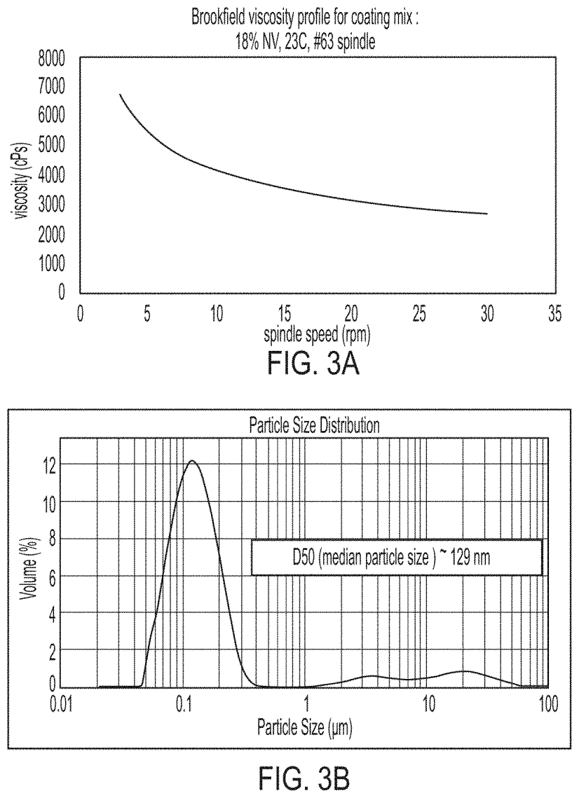

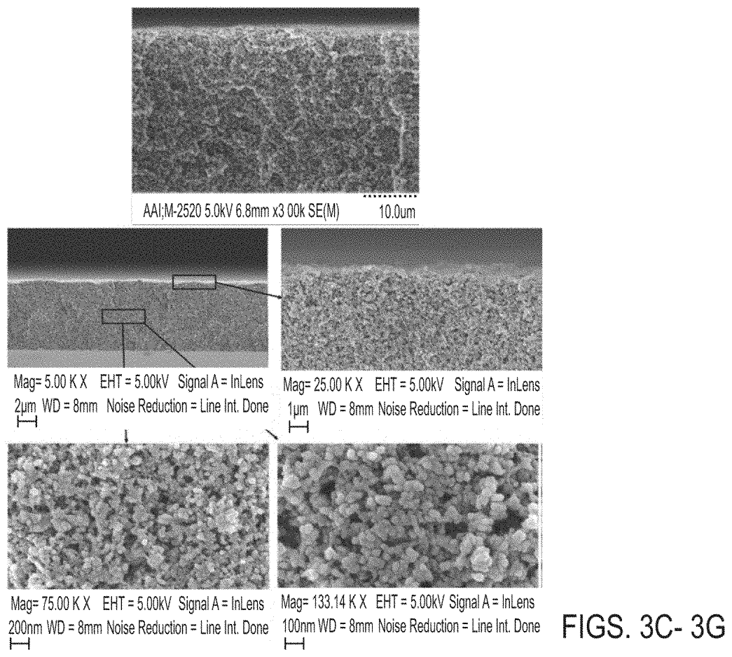

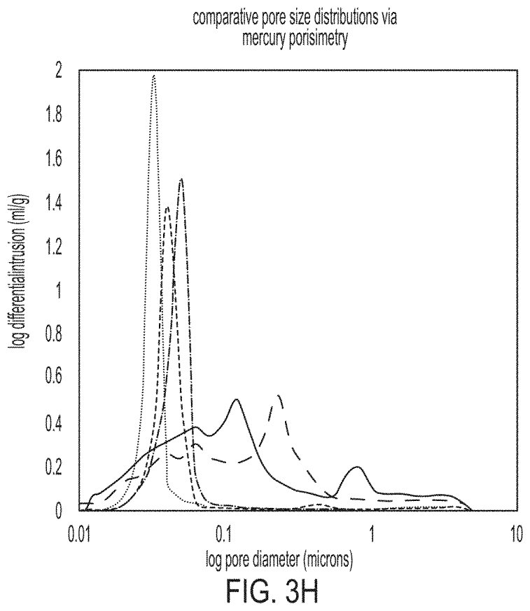

Samples of a coating mix by processes 100a-100c described above, as shown in FIGS. 1A-IC, were made for characterization. In particular, for this Example, samples with proportions conforming to CSP-A described above in Example 1 were made. FIGS. 3A and 3B are graphs reflecting the viscosity profile and particle size distribution, respectively, of the CSP-A ceramic separator coating mixture material resulting from process 100c illustrated in FIG. 1C. Using a Brookfield viscometer with a #63 spindle, the viscosity of a 18% NV coating mix at 23° C. ranged from about 5,000 cPs at a spindle speed of 5 rpm to about 3,000 cPs at a spindle speed of 30 rpm. As shown in FIG. 3B, the CSP-A coating mix exhibited a notable particle size concentration near a median of 129 nm, with a narrow distribution range for a significant proportion of the mixture, with some larger agglomerates with particle size diameters from about 1.5 microns to about 30 microns. These larger agglomerates may be substantially reduced by suitable filtration of the coating mixture. The narrow particle size distribution is reflected in the micrographs of CSP-A mix samples in FIGS. 3C, 3D, 3E, 3F, and 3G, which show relatively uniform particle sizes. The boehmite particles used in this Example 2 have a near-cubic shape.

Correspondingly, as reflected in FIG. 3H, CSP-A separator samples exhibited a narrow pore size distribution around approximately 35 nm as shown in the highest narrow peak in FIG. 3H. This pore size peak is similar to the crystallite size of the primary particles of both of the two different boehmites in the CSP-A separator. The CSP-B and CSP-B2 separator samples show a correspondingly narrow distribution around approximately 50 nm and 60 nm, respectively, that is intermediate between the primary particle crystallite sizes of the two grades of boehmite particles in the CSP-B and CSP-B2 separators. The other two pore size curves in FIG. 3H are two different commercial ceramic-coated separators (CCS). One CCS curve shows relatively broad pore size diameter peaks at about 0.1 microns and about 0.9 microns that are superimposed on the typical very broad pore size distribution curve of the polymer substrate from about 20 nm, or 0.02 microns, to about 0.6 microns with a broad peak at about 80 nm, or 0.08 microns. The other CCS curve shows a relatively broad pore size peak for the ceramic coating at about 0.4 microns that is superimposed on the very broad pore size curve of the polymer substrate.

III. Ceramic Die Coating Process

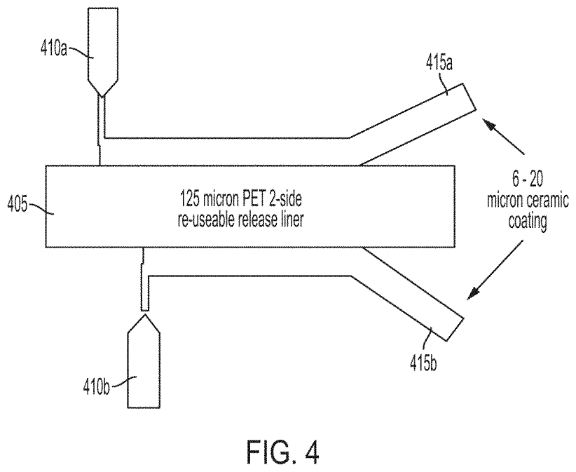

A process for making a thin film ceramic precursor to a CSP separator according to an exemplary embodiment of the present invention is shown in FIG. 4. First, a thick non-porous polymer substrate 405—for example, a 125 μm PET (polyethylene terephthalate) 1-side or 2-side coated, as illustrated in FIG. 4, re-usable release liner—is disposed in correspondence with one or more ceramic coating mix dispensers 410a—and, optionally, 410b—on either side thereof. The liner 405, or the dispenser(s) 410a and 410b, maybe conveyed in a machine direction (MD) while the ceramic coating mix resulting from process 100c is dispensed from dispenser(s) 410a and 410b. According to an exemplary embodiment of the invention, the coating mix is dispensed by slot die coating at approximately 1.5-2 meters wide and at up to approximately 125 m/min MD line speed on a re-useable release liner or continuous belt casting. As shown in FIG. 4, the mix after drying is formed to film(s) 415a and 415b of approximately 6-20 μm in thickness. The resulting film(s) 415a and (optionally) 415b from dispenser(s) 410a and 410b, respectively, on opposing sides of liner 405 is(are), then, removed from liner 405 by delamination for further treatment, as described below, to form free-standing porous CSP film separators.

According to an exemplary embodiment of the invention, the films 415a and 415b are removed from liner 405 and slit to width for assembly into a battery cell. Vacuum drying, as further described below, may be conducted before and/or after the films 415a and 415b are assembled into cells prior to filling the cells with electrolyte.

Given the high filler loading, high viscosity, specific preferred solvent system (NMP), and particular rheological characteristics, pumping of the coating mix fluid to (and through) a coating die—for example, dispensers 410a and 410b—may present unique challenges. According to an exemplary embodiment of the invention, progressive cavity pumps with appropriate NMP-resistant fittings may be used for feeding dispensers 410a and 410b for continuous use without degradation of the pump or the coating fluid.

IV. Cell Fabrication

Following die coating, in accordance with exemplary embodiments of the invention and as described in further detail below, the film 415a (and/or) 415b may undergo one or more processes for characteristic improvements, including, but not limited to, one or more of: vacuum drying (VD); crosslinking (or cross-linker coating); and edge reinforcement (ER). As detailed below, VD may be conducted before and/or after cell stacking or inserting the cell stacks into a casing (and before electrolyte filling). As also described in further detail below, the die coat film (415a and/or 415b), and separators made by alternative coating methods such as gravure coatings, may contain multiple ceramic coating layers and may be incorporated with one or more non-swelling layers and/or safety shutdown layers before cell fabrication in accordance with exemplary embodiments of the invention.

When ready for cell fabrication, the separator film (415a and/or 415b) after slitting is rolled into reel form for cell stacking. Cell stacking can be performed by a number of known processes and the characteristic improvements to the separator film (415a and/or 415b), described above and detailed below, address issues presented by such cell stacking and associated cell fabrication processes—for example, edge reinforcement processing on the separator film (415a and/or 415b) improves, among other factors, edge tear resistance when the film is handled by cell stacking and fabrication machinery.

In accordance with an exemplary embodiment of the invention, the separator film (415a and/or 415b), in reel form, is pulled through a z-fold stacking machine in a central “stacking” location. Cell stacking is performed, preferably, in a clean room environment. The separator is then folded back and forth as anodes and cathodes are placed on the stack. Once the stack is built up with enough electrode layers (for example, 17 cathodes and 18 anodes in a stack), the separator is wound around the stack a predetermined number of times and cut/taped to form a “dry cell stack.” The “dry cell stack” is then moved to a tabbing/welding station—for example, ultrasonic welding—for connecting the anode and cathode tabs to create the two respective leads (plus and minus). The tabbed cells are then placed in a HiPot (defect) tester, where a high voltage is applied for a short amount of time. If there is a hole in the separator or other defect that causes the cell to short-circuit or the current to jump, the cell would be rejected. Accepted stacks are then placed into a casing, such as a pouch, and sealed, leaving an opening for adding electrolyte (electrolyte filling) via the opening in the pouch. Once the electrolyte filling step is completed, the pouch is completely sealed. The cells then undergo final cell formation processing, which may include heating the cells to form gas that is then removed by opening the pouch and resealing it. The cells may also be cycled (charged and discharged) a predetermined number of times in a cell formation process before being released as a finished cell product for end use.

V. Shutdown Layer

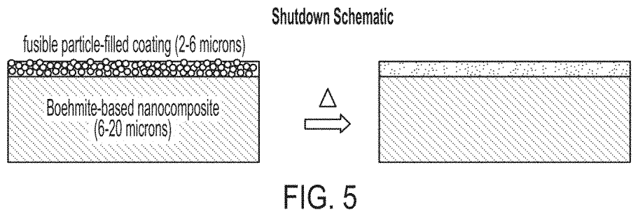

In accordance with an exemplary embodiment of the invention, one or more shutdown layers of a porous thermally fusible particle-filled coating may be disposed on either or both sides of a ceramic-based nanocomposite to form a free-standing CSP separator. The shutdown layer may also be intermediate between two ceramic-based nanocomposite layers. FIG. 5 illustrates a schematic cross-sectional view of a CSP separator incorporating a shutdown layer, which may be disposed on a surface proximate the anode and/or the cathode of a lithium-ion battery upon fabrication. As shown in FIG. 5, the ceramic-based (e.g., boehmite) nanocomposite layer may have a thickness of approximately between 6-20 μm and the shutdown layer coating may have a thickness of approximately between 2-6 μm. In the cell, the shutdown layer functions to block the flow of lithium ions when the cell becomes overheated, such as at 110° C., thereby shutting down the operation of the cell and preventing more discharge of the cell's energy. This blocking of the cell's operation results from a major increase in the impedance or resistance of the cell from the loss of porosity in the separator. This loss in porosity upon heating in the cell corresponds to a large increase in the Gurley permeability number for the separator when heated.

### Example 3

Testing was conducted on the thermal stability of lithium-ion cells comprising CSP films produced in the manner described above. In particular, Accelerating Rate Calorimetry (ARC) was performed on such lithium-ion cells against cells with a variety of different separators, all in pouch form with approximately 5 Ah in rated discharge capacity, namely:
a. Two Ceramic (only) membranes (20 micron “CSP” with the CSP-A design)
b. Two Ceramic-coated polyolefin separators (“CCS Shutdown on Anode”)
c. One Ceramic (only) membrane (CSP-A) with a shutdown coating facing negative electrode (“Shutdown on Anode”)
d. One Ceramic (only) membrane (CSP-A) with shutdown coating facing positive electrode (“Shutdown on Cathode”)
e. Two Controls (16 micron polyolefin (PE) separator)

For the “CSP” ARC testing in this Example, pouch cells with the CSP-A version separator were used. The cells were fully-charged using a CC/CV charge protocol with 0.5 C charge rate, 4.20 V charge cut-off voltage and a C/20 rate taper charge cut-off. The cells utilized a lithium nickel manganese cobalt oxide (NMC) positive electrode chemistry and carbon (graphite) negative electrode chemistry. Excess pouch material was folded and taped down. Insulated wires were connected to the cell tabs and then connected to an external data-logger for voltage measurements during testing. The cells were placed in an Accelerating Rate Calorimeter (ARC) chamber and a thermocouple was affixed to the side of the pouch using high-temperature tape.

The ARC testing was performed in a “Heat-Wait-Search” Mode where an ARC heats the chamber to the starting temperature, 50° C., and waits until the sample temperature matches the chamber temperature. The system then waits a prescribed amount of time while searching for an exotherm from the sample. If an exotherm is not detected, the system heats the chamber and sample to the next step (heat step=5° C.). If an exotherm above the threshold is detected, the ARC continues to match the chamber temperature to the sample temperature and no longer undergoes heating steps (adiabatic region). The results are shown in Table 2.

TABLE 2

| | | | First Cell |
|---|---|---|---|
| | Onset Temp | Voltage Drop | Exotherm |
| Cell | (° C.) | Temp (° C.) | Temp (° C.) |
| “CSP 1” (CSP-A) | 158 | 192 | 218 |
| “CSP 2” (CSP-A) | 152 | 204 | 216 |
| “CCS On Anode 1” | 87 | 129 | 132 |
| “CCS On Anode 2” | 145 | 167 | 221 |
| “Shutdown on | 91 | 105 | 168 |
| Cathode” (CSP-A | | | |
| w/shutdown) | | | |
| “Shutdown on | 102 | 166 | 168 |
| Anode” (CSP-A | | | |
| w/shutdown) | | | |
| Control 1 | 123 | 129 | 131 |
| Control 2 | 129 | 127 | 130 |

Referring to Table 2, when tested in an adiabatic environment (no heat loss to surroundings) the cells began to self-heat with the following properties. The CSP-A cells (or “CSP 1” and “CSP 2”) (2 tested) demonstrated self-heat onset when the cell temperature was >150° C. Other cells tested exhibited onset temperatures between 87° C. and 129° C., except for one anomalous “CCS on Anode” sample in which onset occurred at 145° C. Cell voltage behavior (e.g. shut-down or separator failure) depended on the material(s) of the separator. The cells with polymeric separators (full or partial), except for the one anomalous “CCS on Anode” sample, exhibited voltage drops around 130° C., consistent with melting temperatures of common polymeric polyethylene (PE) separator materials. The two “CSP” cells maintained the cell voltage until the temperature of the cell was >190° C. Sudden heating events were apparent in most cells before full cell failure (defined as when d²T/dt²>100° C./min²). Heating events were observed in non-“CSP′” cells between 120° C. and 170° C. except for the one anomalous “CCS on Anode” sample in which onset of the exotherm was above 200° C. (the other polymer separator cells showed onset of the exotherm at about 130° C.). Heating events occurred in both “CSP” cells above 200° C. and appear to have been induced by the opening of the seal of the pouch cell and the release of the volatile electrolyte solvents. As reflected in these results, the tested CSP-A cells with their lack of shrinkage at temperatures to 220° C. and above maintained operation through higher temperatures against the comparative cells, with both higher self-heating onset and voltage drop temperatures. The improved results against, at least, the “CCS” and “Control” samples are attributable to the absence of a porous polymer substrate that shrinks and melts at about 130° C.

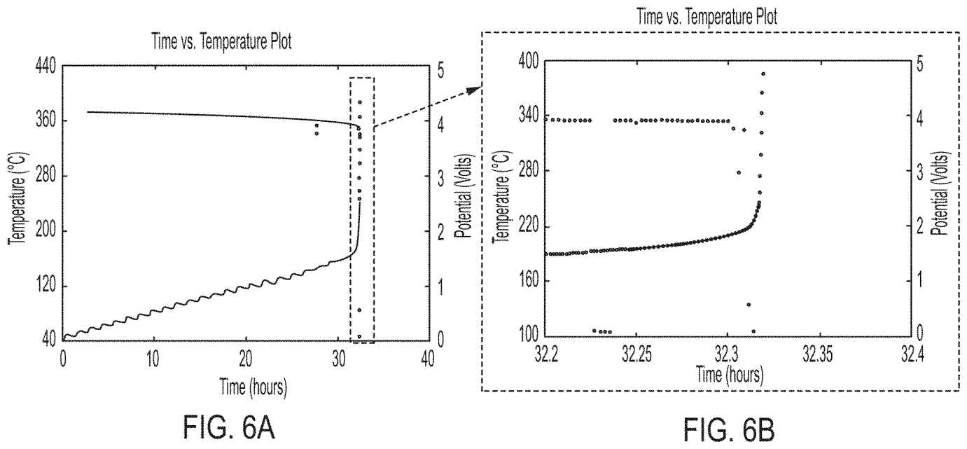

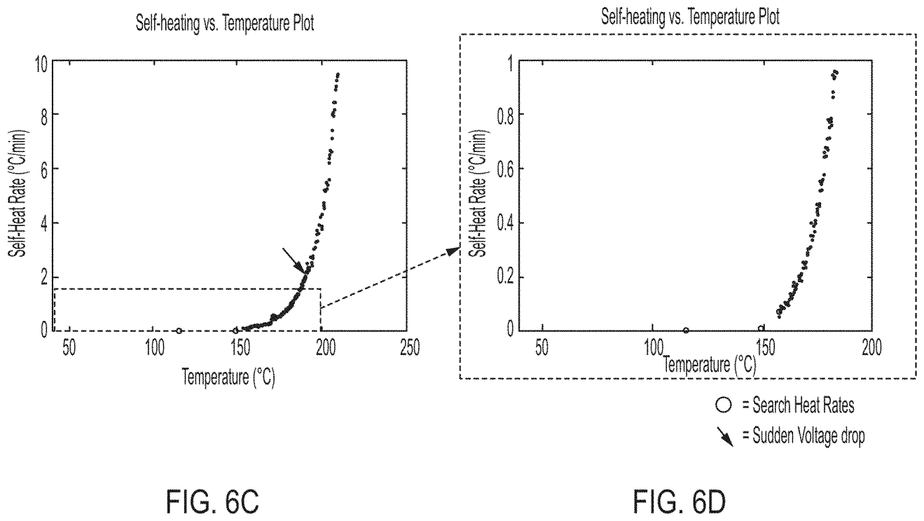

FIGS. 6A, 6B, 6C, and 6D are graph plots reflecting the “Time vs. Temperature” and “Self-Heating Rate vs. Temperature” results, respectively, in the ARC testing for the “CSP 1” cell with a 20 μm thick CSP-A separator. FIGS. 6B and 6D are magnified portions of FIGS. 6A and 6C, respectively. The “CSP 1” cell was tested with an open-circuit Voltage of 4.1410 V. As shown in FIGS. 6A-6D, particular results over time of the ARC testing were as follows:
a. Temperatures (° C.):
   i. Onset: 157.5
   ii. Sudden Voltage Drop: 192.0
b. Times (Hours):
   i. Onset: 30.1
   ii. Voltage Drop: 32.2

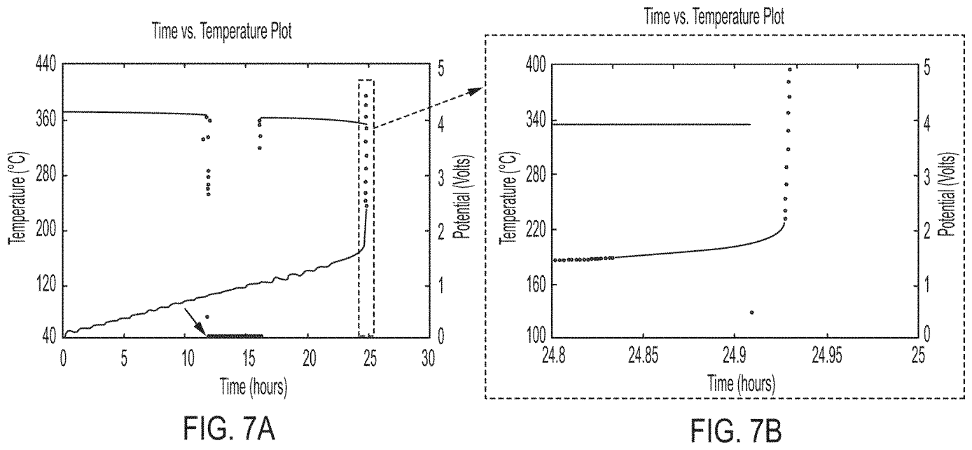

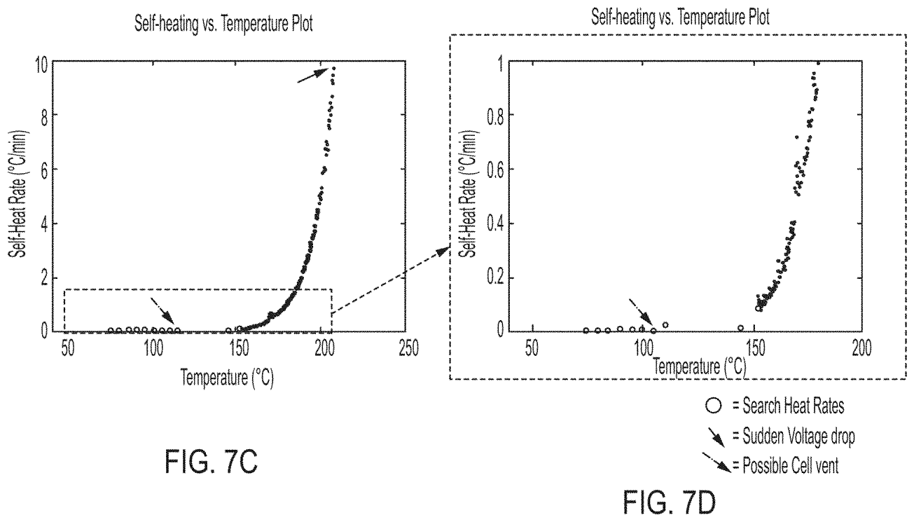

FIGS. 7A, 7B, 7C, and 7D are graph plots reflecting the “Time vs. Temperature” and “Self-Heating Rate vs. Temperature” results, respectively, in the ARC testing for the “CSP 2” cell with a 20 μm CSP-A separator. FIGS. 7B and 7D are magnified portions of FIGS. 7A and 7C, respectively. The “CSP 2” cell was tested with an open-circuit Voltage of 4.126 V. As shown in FIGS. 7A-7D, particular results over time of the ARC testing mainly correspond to those of “CSP 1” shown in FIGS. 6A-6D as follows:
a. Temperatures (° C.):
   i. Onset: 152.2
   ii. Sudden Voltage Drop: 204.3
   iii. Vent: 110
b. Times (Hours):
   i. Onset: 30.1
   ii. Voltage Drop: 32.2
   iii. Vent: 14

As shown in FIG. 7A, the cell voltage was recorded at “0 V” for several hours during the middle of the test, which was possibly due to swelling of the cell pouch during heating. FIGS. 7C and 7D show possible cell venting at 110° C., which is typically noted by a sudden drop in the temperature of the cell (and self-heat rate), while the cell is self-heating in adiabatic conditions.

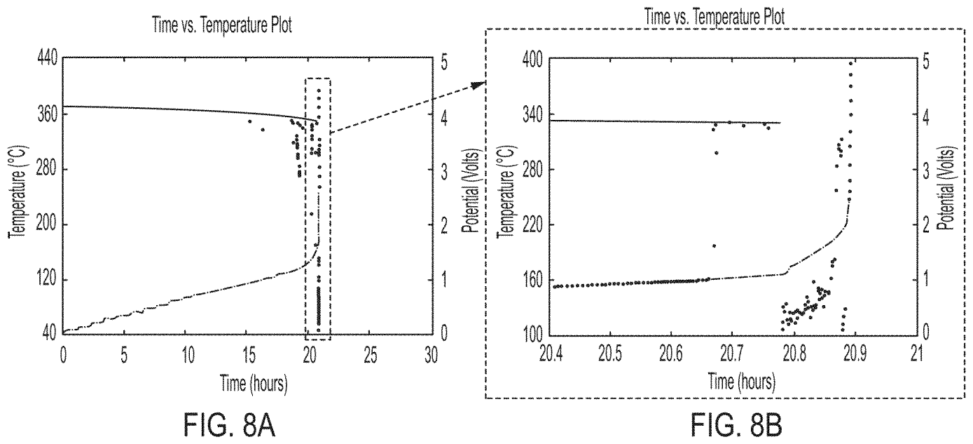

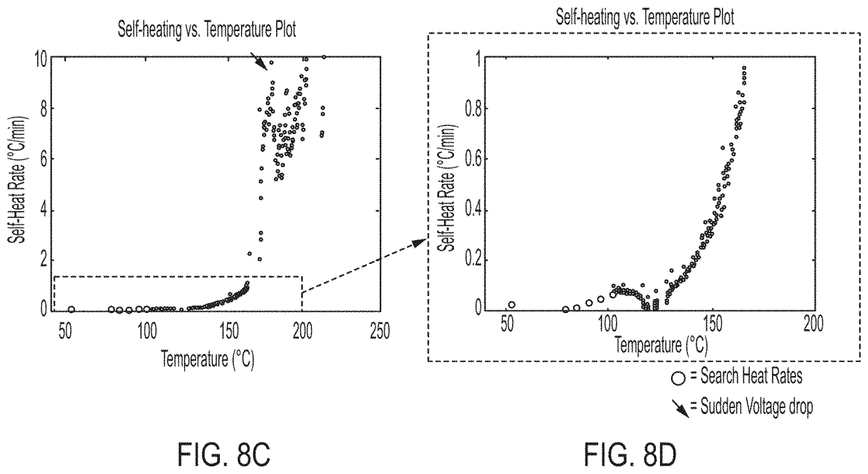

FIGS. 8A, 8B, 8C, and 8D are graph plots reflecting the “Time vs. Temperature” and “Self-Heating Rate vs. Temperature” results, respectively, in the ARC testing for the “Shutdown on Anode” (i.e., a CSP-A separator with a shutdown layer proximate the anode) cell. FIGS. 8B and 8D are magnified portions of FIGS. 8A and 8C, respectively. The cell was tested with an open-circuit Voltage of 4.108 V. As shown in FIGS. 8A-8D, particular results over time of the ARC testing were as follows:
a. Temperatures (° C.):
   i. Onset: 102.2
   ii. Sudden Voltage Drop: 166.0
b. Times (Hours):
   i. Onset: 11.7
   ii. Voltage Drop: 20.8

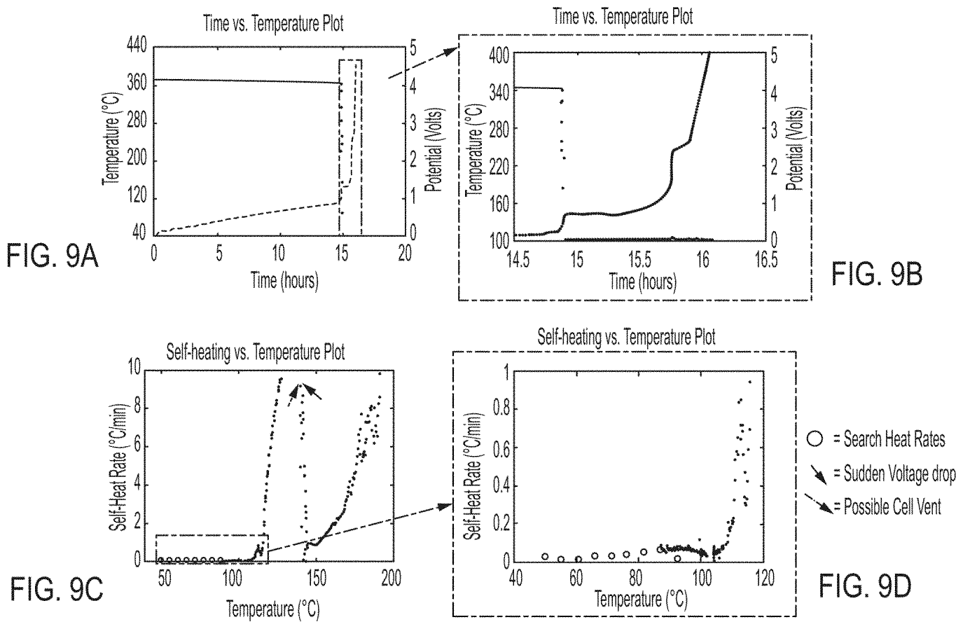

For comparison with the “Shutdown on Anode” cell, testing was performed on a “CCS on Anode 1” cell, results of which are shown in FIGS. 9A-9D. FIGS. 9B and 9D are magnified portions of FIGS. 9A and 9C, respectively. The cell was tested with an open-circuit Voltage of 4.131 V. As shown in FIGS. 9A-9D, particular results over time of the ARC testing, with notable deficiencies when compared to “Shutdown on Anode,” were as follows:
a. Temperatures (° C.):
   i. Onset: 87.1
   ii. Sudden Voltage Drop: 129.0
   iii. Vent: 144.5 (plot)
b. Times (Hours):
   i. Onset: 8.6
   ii. Voltage Drop: 14.9
   iii. Vent: 14.9

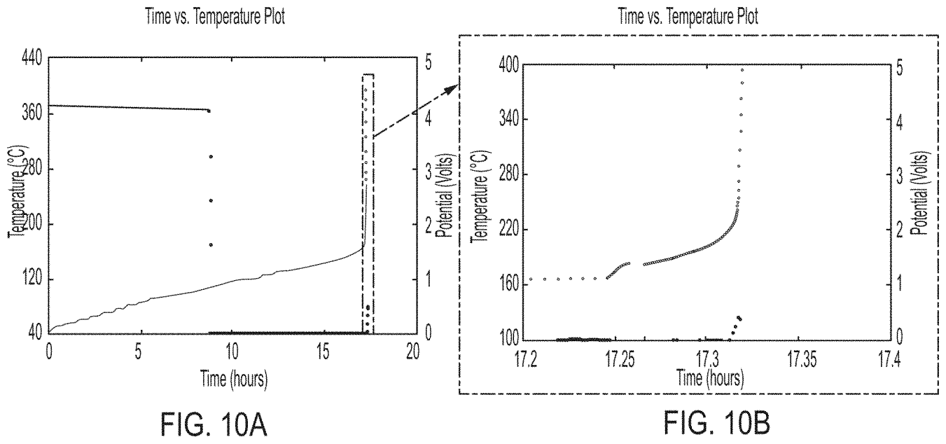

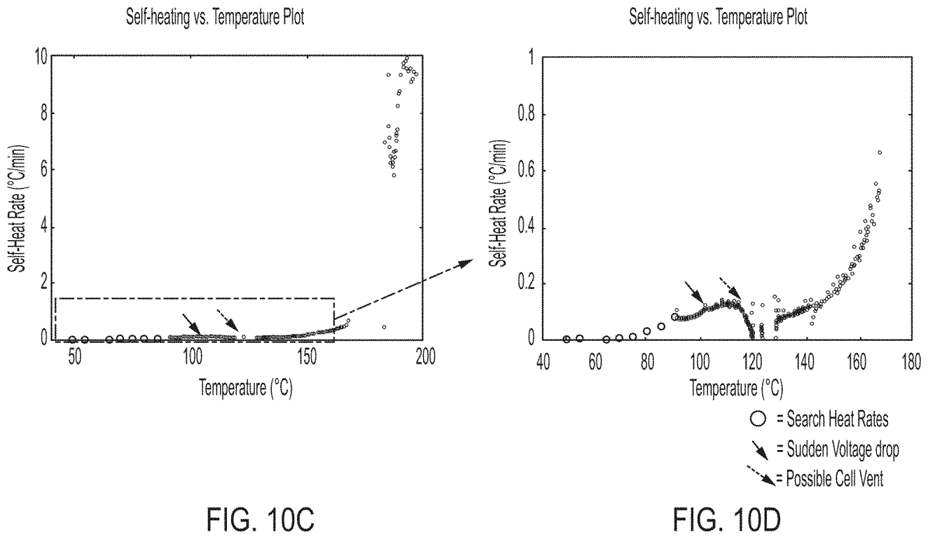

FIGS. 10A, 10B, 10C, and OD are graph plots reflecting the “Time vs. Temperature” and “Self-Heating Rate vs. Temperature” results, respectively, in the ARC testing for the “Shutdown on Cathode” (i.e., a CSP-A separator with a shutdown layer proximate the cathode) cell. FIGS. 10B and 10D are magnified portions of FIGS. 10A and 10C, respectively. The cell was tested with an open-circuit Voltage of 4.122 V. As shown in FIGS. 10A-10D, particular results over time of the ARC testing were as follows:
a. Temperatures (° C.):
   i. Onset: 91.0
   ii. Sudden Voltage Drop: 105.1
b. Times (Hours):
   i. Onset: 6.0
   ii. Voltage Drop: 8.7

Achieving shutdown at 105° C. has long been a desired result for lithium ion cells because lithium ion cells typically experience a rapid thermal runaway starting at about 110° C., so it is important to terminate the operation of the cell before it reaches the temperature of thermal runaway. Further, for safety and cell performance reasons, lithium ion cells should not be used after they have reached about 100° C. and experienced some degradation of the cell, so shutting the cell down at 105° C. automatically prevents any further use or operation of the lithium ion cell. As can be seen in the below examples, CCS with a PE substrate and PE separators do not shut down until a much higher temperature, such as at 125° C. to 130° C. or higher, and also show high exothermic heat buildup and cell fires at those temperatures and thus are not safety shutdown layers that consistently prevent fires and explosions in lithium ion electrochemical cells containing volatile and flammable organic electrolyte solvents.

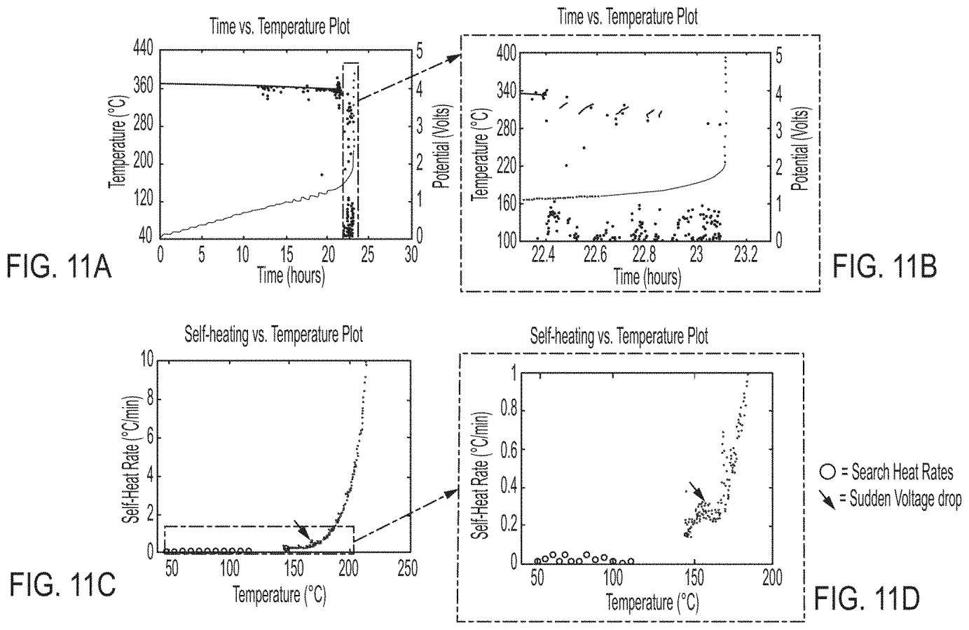

For further comparison with the “Shutdown on Anode” cell, testing was performed on a “CCS on Anode 2” cell, results of which are shown in FIGS. 11A-11D. FIGS. 11B and 11D are magnified portions of FIGS. 11A and 11C, respectively. The cell was tested with an open-circuit Voltage of 4.122 V. As shown in FIGS. 11A-11D, particular results over time of the ARC testing were as follows:
a. Temperatures (° C.):
   i. Onset: 145.1
   ii. Sudden Voltage Drop: 167.0
b. Times (Hours):
   i. Onset: 20.9
   ii. Voltage Drop: 22.4

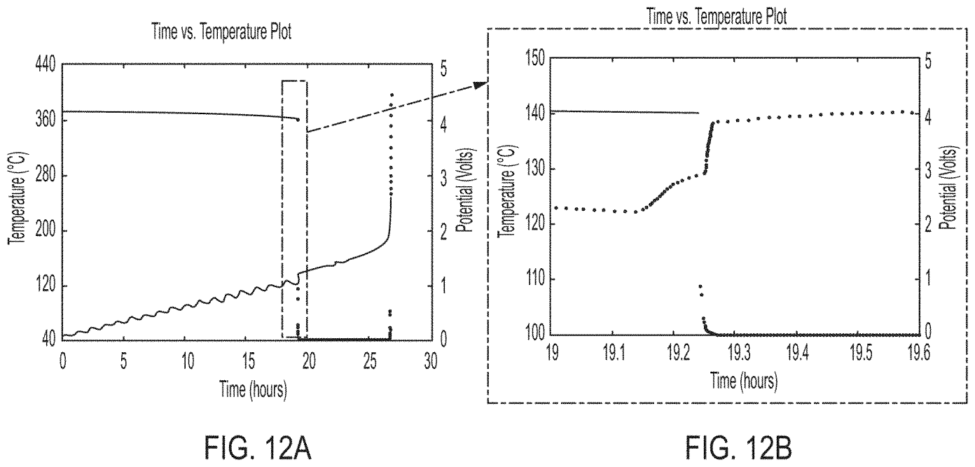

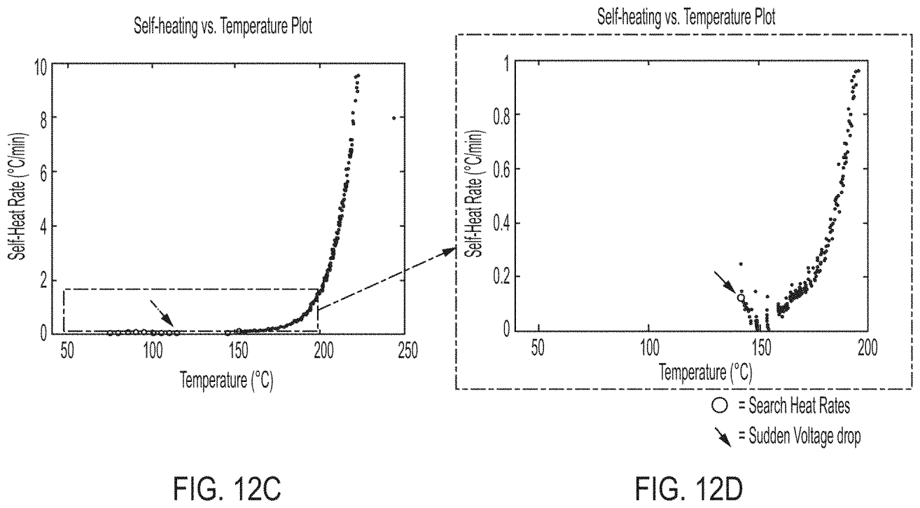

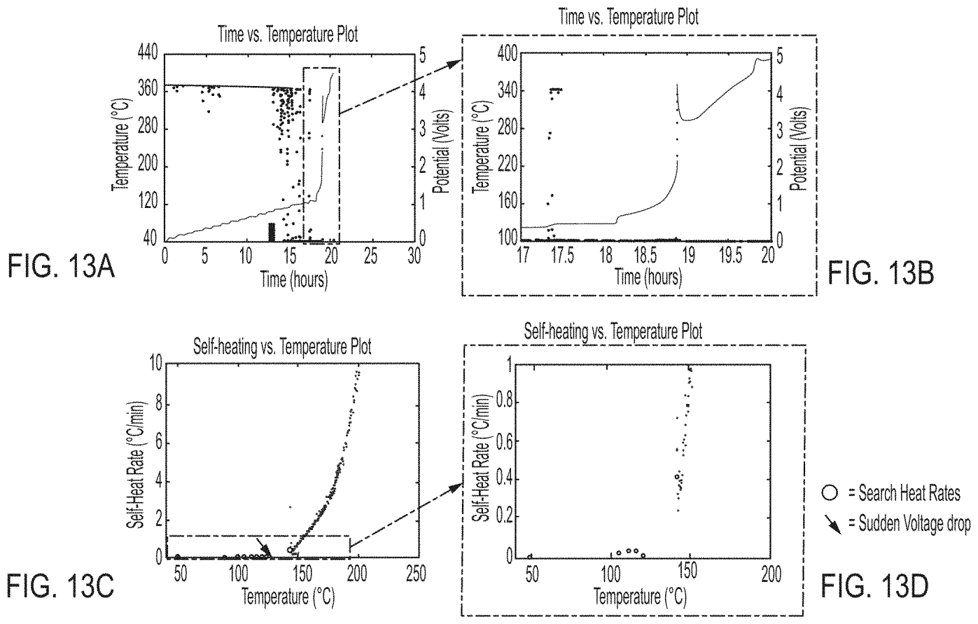

Finally, for comparison with the “CSP” cells, tests were conducted on PE separator cells “Control 1” and “Control 2,” the results of which are shown in FIGS. 12A-12D and 13A-13D, respectively. For “Control 1,” FIGS. 12B and 12D are magnified portions of FIGS. 12A and 12C, respectively. The “Control 1” cell was tested with an open-circuit Voltage of 4.154 V. As shown in FIGS. 12A-12D, particular results over time of the ARC testing, with notable deficiencies when compared to “CSP 1” and “CSP 2,” were as follows:
a. Temperatures (° C.):
   i. Onset: 122.6
   ii. Sudden Voltage Drop: 128.7
b. Times (Hours):
   i. Onset: 19.1
   ii. Voltage Drop: 19.2

For “Control 2,” FIGS. 13B and 13D are magnified portions of FIGS. 13A and 13C, respectively. The “Control 2” cell was tested with an open-circuit Voltage of 4.192 V. As shown in FIGS. 13A-13D, particular results over time of the ARC testing, with notable deficiencies when compared to “CSP 1” and “CSP 2,” were as follows:
a. Temperatures (° C.):
   i. Onset: 129.1
   ii. Sudden Voltage Drop: 126.9
b. Times (Hours):
   i. Onset: 18.2
   ii. Voltage Drop: 17.4

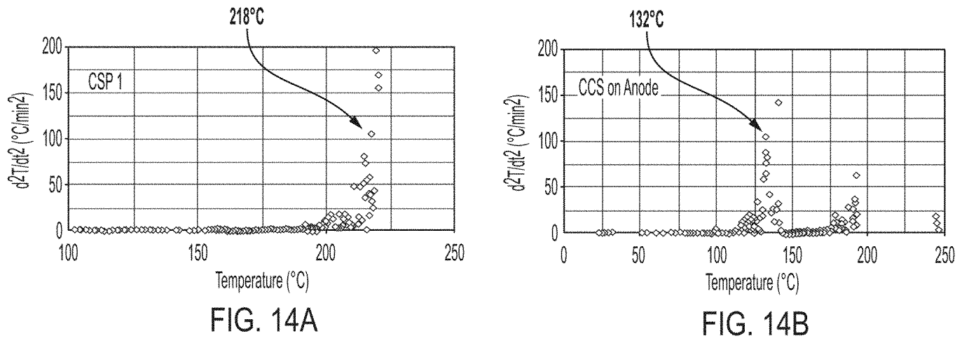

In summary, the “CSP 1” and “CSP 2” cells showed notable improvement in thermal stability, particularly in comparison to conventional CCS and PE “control 1” and “control 2” cells. FIGS. 14A and 14B are selective plots of Sudden Heating Events (d²Tdt²>100° C./min²—i.e., second derivative of the heat rate) for “CSP 1” and “CCS on Anode 1” before complete cell failure. As shown in these figures and in Table 2, the “CSP 1” cell did not exhibit a sudden heating, very exothermic event until after the cell had exceeded 200° C. and reached 218° C. In contrast, the “CCS on Anode 1” sample underwent a sudden heating, very exothermic event at 132° C. As shown in Table 2, the two cells with PE separator samples also had sudden heating events around 132° C.

### Example 4

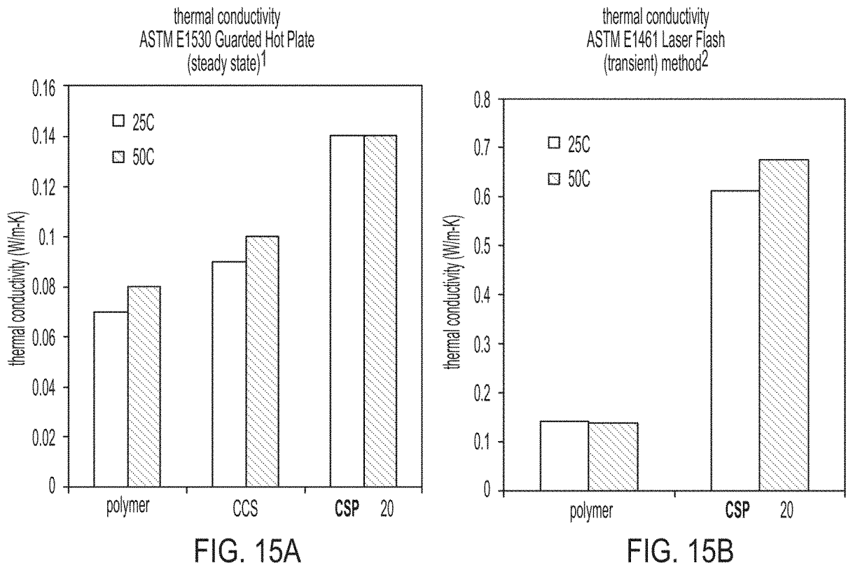

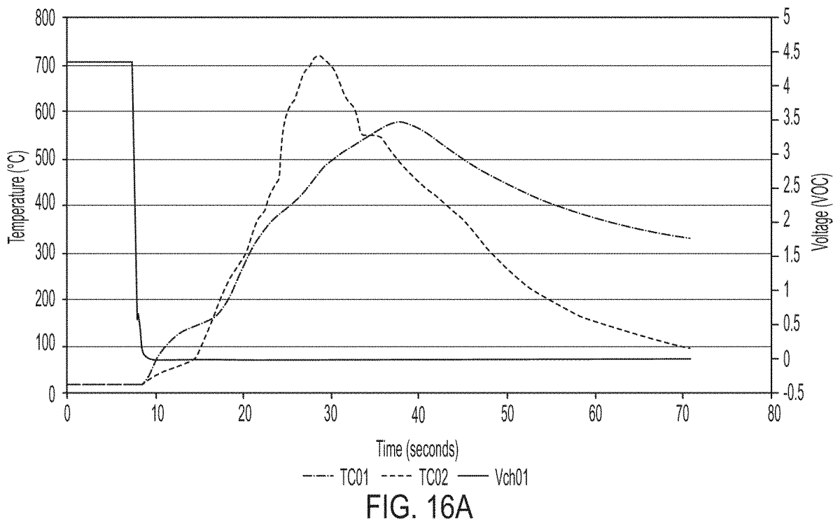

Testing was also conducted on the thermal conductivity of CSP films for use as separators produced in the manner described above, with comparisons to CCS and polymer sheets having corresponding dimensions. For the “CSP” thermal conductivity testing in this Example, a CSP version separator with two different treated boehmites, similar to the CSP-A version was used. The advantages of excluding any polymer substrate, as in a traditional CCS separator, is confirmed by laser flash (transient) tests conforming to ASTM E1461 on the 20 μm CSP separator (“CSP 20”) and the PE polymer sheet. The ASTM E1461 method is accurate in providing quantitative and reproducible thermal conductivity measurements for thin separator samples. As reflected in FIG. 15, the CSP separator showed notable improvement in thermal conductivity at both 25° C. and 50° C. temperatures with about a 10/o higher thermal conductivity at 50° C. compared to 25° C.—approximately 0.6-0.7 W/m-K compared to approximately 0.14-0.15 W/m-K for the polymer sheet. Higher thermal conductivity in the separator is useful in faster spreading of any heat buildup in the cell to reduce the temperature of hot spots to provide improved safety results if a short circuit or other sudden heating event occurs in an area of the cell.

### Example 5

Nail penetration safety testing was conducted on lithium-ion pouch cells incorporating CSP films produced in the manner described above as separators, with comparisons to pouch cells incorporating PE (polyethylene) polymer separators. Separate tests were conducted on 3.5 Ah capacity cells and 75 Ah cells, respectively. For the “CSP” nail penetration safety testing in this Example, pouch cells with the CSP-A version separator were used.

The high voltage 3.5 Ah pouch cells were charged to 4.4 V prior to testing and a 3 mm diameter nail was driven to penetrate the approximate center of the cell at approximately 8.13 cm/s. The results of the tests are shown in Table 3 below.

TABLE 3

| Separator | Peak Temp. (° C.) | Comments |
|---|---|---|
| PE (polyethylene) | 700 | Swells, vents, smokes, |
| | | sparks, flame |
| CSP-A | 54 | Swells |

The 75 Ah pouch cells were charged to 4.1 V prior to testing and a 3 mm diameter nail was driven to penetrate the approximate center of the cell at approximately 8 cm/s. The results of the tests are shown in Table 4 below.

TABLE 4

| Separator | Peak Temp. (° C.) | Comments |
|---|---|---|
| PE | 600 | Swells, vents, smokes, |
| | | chars, flame |
| CSP-A | 80 | Swells slightly |

As shown in both Tables 3 and 4, the CSP cells provided substantially improved mechanical and attendant fire safety in the nail penetration test, with both sets of tests showing no ignition in the CSP cells and peak temperatures below 100° C. As cells become larger, such as 40 Ah cells or larger, and as cells use less safe electrode materials, such as 80:10:10 nickel manganese cobalt (811 NMC) and high nickel cobalt aluminum (NCA) cathode materials and silicon anode materials, it becomes increasingly difficult to pass the nail penetration tests with CCS, and particularly with PE separators. Safety is the most important property in lithium ion batteries and is an absolute requirement, so it is very beneficial if the separator is very heat stable and thermally conductive and can by itself enhance the battery safety compared to CCS and plastic separators. There are other cell designs that are known to improve the safety of lithium ion cells but they are expensive and sometimes not consistently effective, so it is very helpful to be able to use a separator with excellent safety properties. Accordingly, the testing reflects improved safety of cells incorporating CSP separators formed in accordance with the invention in the manner described herein, in preventing ignition events and in maintaining below ignition peak temperatures through induced mechanical failures, such as penetration of the separator and cell by a conductive metal, while in operation.

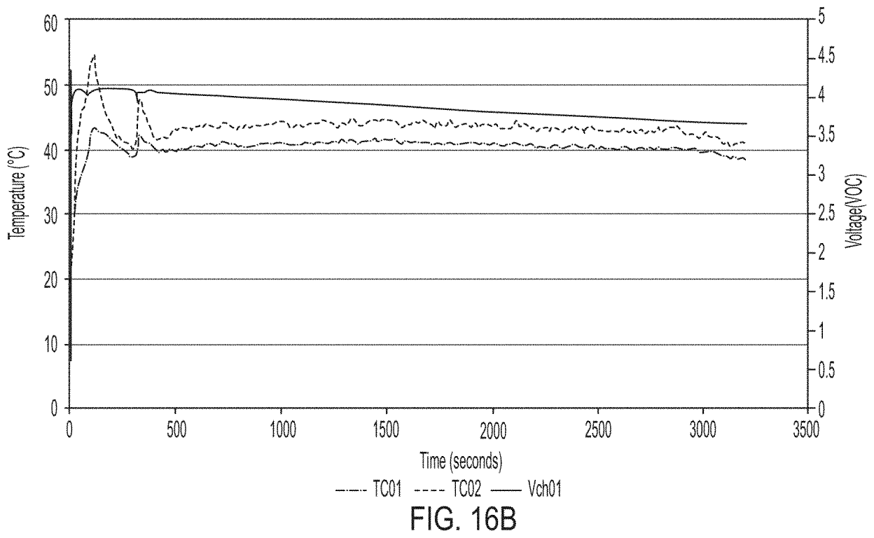

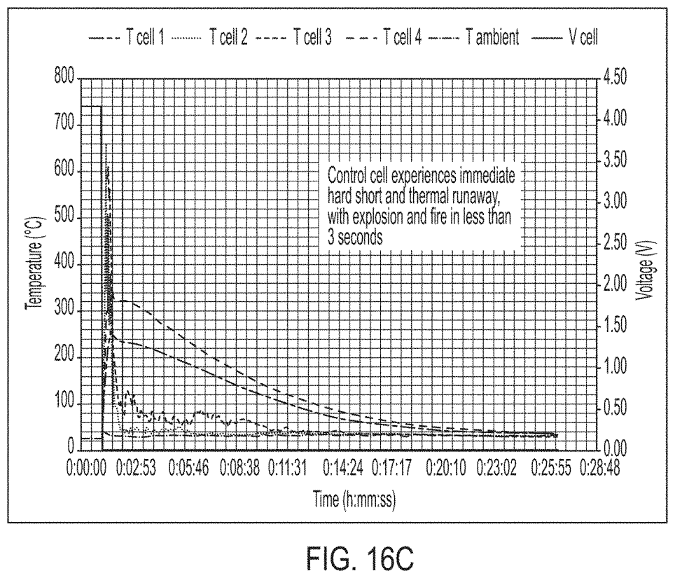

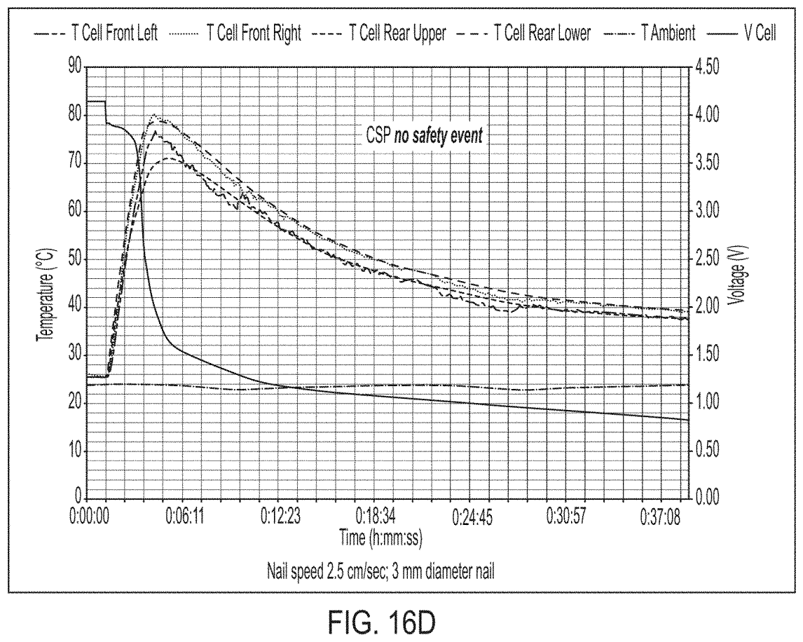

FIGS. 16A and 16B are graph plots on Temperature and Voltage over the duration of the nail penetration test for the 3.5 Ah “Control” PE cells and CSP-A cells, respectively. As shown in these figures, the PE separator cell suffered a voltage drop after only 10 seconds and temperature increased to 700° C. on one thermocouple on the surface of the cell and to about 580° C. on a second thermocouple attached to the surface of the cell in a different location after nail penetration. These peak temperatures of 700° C. and 580° C. were reached in only 30 to 40 seconds after the nail penetration. In contrast, as shown in FIG. 16B, the CSP-A cell showed only a slow linear decrease in voltage from 4.2V to 3.6V over the first 3100 seconds after the nail penetration with the peak temperature measured by thermocouples attached at two locations on the outer surface of the cells starting at a peak of about 50° C. and decreasing to about 40° C. as the cell slowly discharged to 3.6V over the 3100 second duration of the nail penetration test. Similar results are shown in FIGS. 16C and 16D for nail penetration tests on 5 Ah pouch cells with a PE separator (Control PE #1 in Table 6) and a CSP-A separator (CSP-A 16 micron in Table 6), respectively. The 5 Ab cell with the PE separator experienced an immediate hard short with explosion and fire in less than 3 seconds. The 75 Ah cell with the 16 micron thick CSP-A separator had a slow discharge over about 5 minutes and no safety events.

Additional nail penetration testing was further conducted on 5 Ah CSP-A pouch cells under varying conditions. For this testing, the electrodes were NMC/graphite, the 5 Ah CSP-A cells were LiPF₆ constructions with an organic carbonate solvent system, and the tests were conducted at 100% state of charge (SOC) (4.2 V). As shown by the results in Table 5 below, all of the CSP cells maintained maximum temperature below 70° C.

TABLE 5

| | | Nail | | |
|---|---|---|---|---|
| | | Diameter | Penetration | Max Temp. |
| Cell | SOC | (mm) | Rate (cm/s) | (° C.) |
| 1 (5 Ah | 100% | 8 | 2.5 | 55.9 |
| CSP-A) | (4.2 V) | | | |
| 2 (5 Ah | 100% | 3 | 2.5 | 65.1 |
| CSP-A) | (4.2 V) | | | |
| 3 (5 Ah | 100% | 3 | 1.0 | 58.3 |
| CSP-A) | (4.2 V) | | | |

For another nail penetration test, 5 Ah pouch cells with 16 micron and 20 micron CSP-A separators were tested at 100% SOC against control polyolefin (PE) separator cells with a 3 mm diameter nail at 2.5 cm/sec penetration speed. As shown in Table 6 below, the CSP-separator cells showed safety improvement.

TABLE 6

| Separator | Peak Temp. (° C.) | Comments |
|---|---|---|
| Control PE #1 | 658.8 | Immediate hard short; |
| | | explosion and fire |
| Control PE #2 | 293.0 | Immediate hard short; |
| | | explosion and fire |
| CSP-A 20 micron | 93.4 | Significant short; |
| | | no safety event |
| CSP-A 16 micron | 80.3 | Significant short; |
| | | no safety event |

In Table 6, an immediate hard short with the PE separator cells was shown by a drop in the voltage to 0 volts and an explosion of the cell in about 3 seconds. This resulted in much of the energy of the cell being discharged immediately and rapidly heating the cell to the very high peak temperatures measured. The significant short with the CSP-A separator was shown by a short that took about 5 minutes to an hour to fully discharge the cell to 0 volts. This much more gradual energy discharge kept the peak temperature in the cell below 100° C. These results are reflected in FIGS. 16C and 16D in the nail penetration testing of the 75 Ah pouch cells. One major reason for this enhanced safety for the CSP of this invention in nail penetration testing is that there is no shrinkage (less than 1% shrinkage, and typically less than 0.5% shrinkage) of the CSP at temperatures up to 600° C. and higher. This lack of shrinkage keeps the hole in the separator from the nail penetration from expanding and exposing a greater area to short circuiting between the anode and the cathode. The thin aluminum metal current collector layer in the cathode melts at around 600° C. if the local temperature on the circumference of the nail reaches that temperature, but the CSP does not melt or shrink and maintains its electrical insulation properties around the nail hole area and thereby slows down the rate of the forced short circuit discharge of the cell and its accompanying high heat buildup. This results in no safety event in the cell in the nail penetration test, i.e., no smoking, charring, flaming or explosion of the cell. Aside from safety and stability testing, cells comprising CSP-A separators made in accordance with exemplary embodiments of the invention, as described above, underwent operational testing to ensure acceptable performance.

### Example 6

Life Cycle testing was conducted on 5 Ah pouch cells incorporating CSP separators with the CSP-A version separator, which showed comparable performance to control polymer (polyolefin)(PE) separator cells. For the “CSP” Life Cycle testing in this Example, pouch cells with the CSP-A version separator were used.

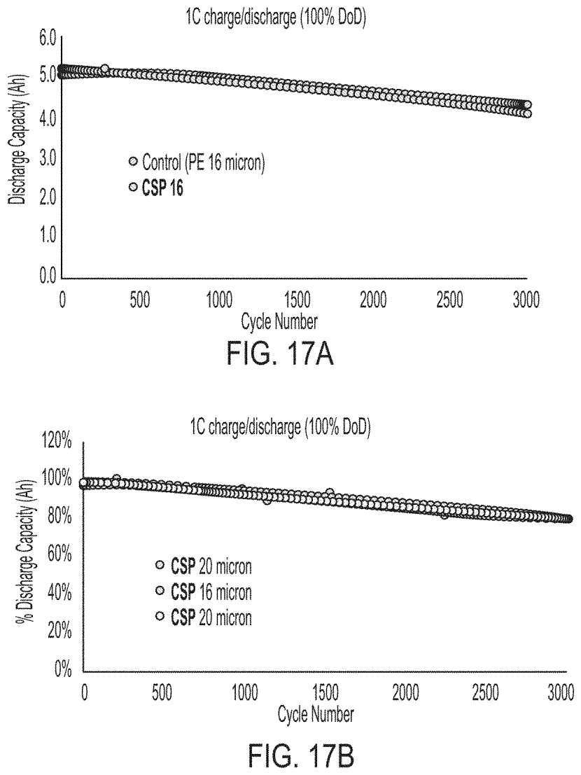

As shown in FIG. 17A, a 5 Ah pouch cell with a 16 μm CSP separator performed comparably to a cell with a 16 μm PE separator over a 3000 charge/discharge life cycle test at IC charge/discharge rates with a capacity retention of about 85%. FIG. 17B shows Life Cycle testing results for various CSP-A of different thicknesses in correspondence with the comparison to the PE separator in FIG. 17A. As shown in these figures, all of the CSP-A cells performed comparably to the PE cell.

### Example 7

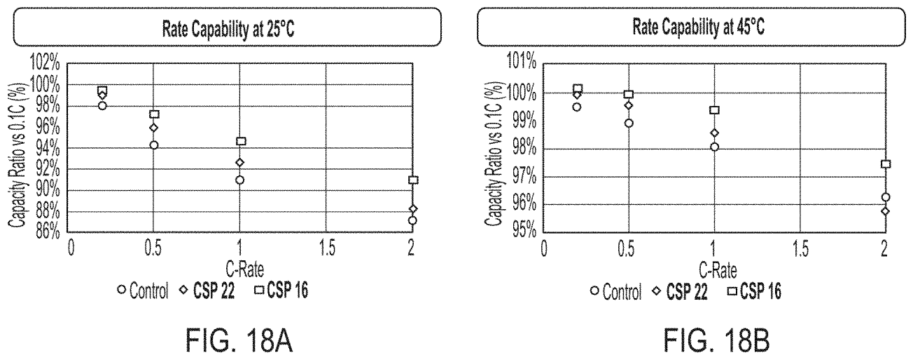

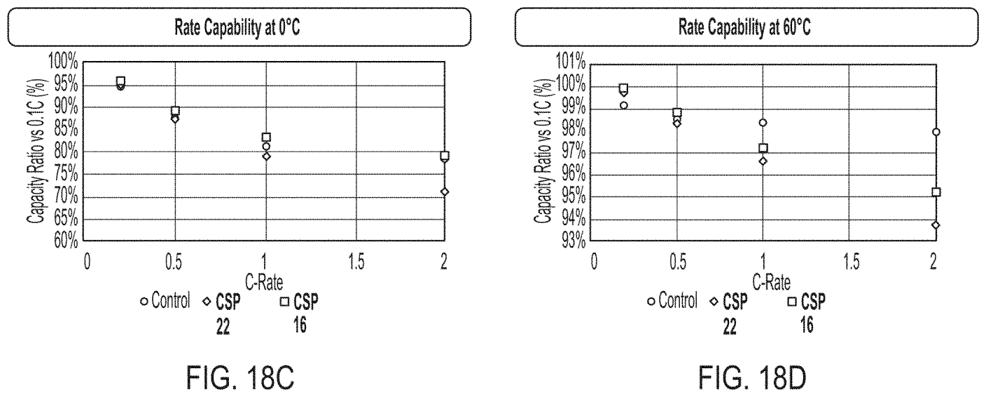

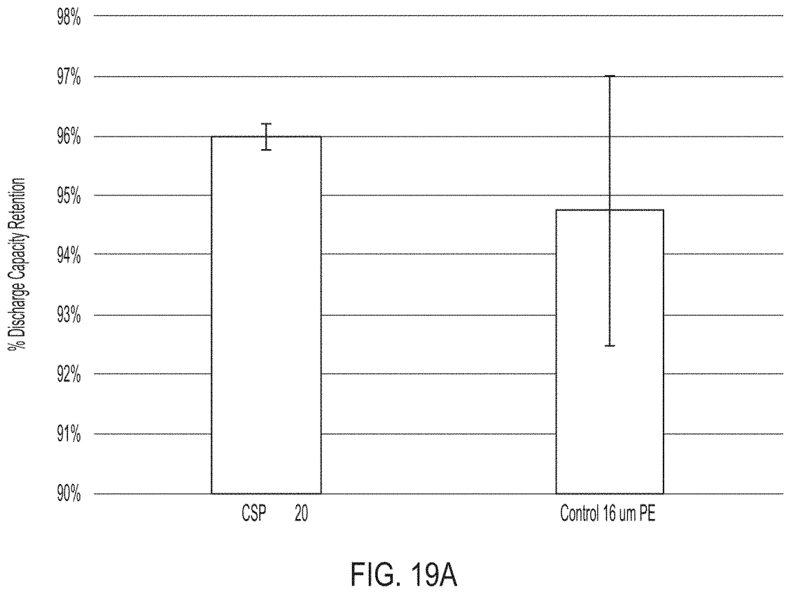

5 Ah pouch cells incorporating CSP-A separators of various thicknesses were evaluated for rate capability. For the “CSP” Rate Capability testing in this Example, pouch cells with the CSP-A version separator were used. As reflected in FIGS. 18A-18D, cells with 16 micron CSP separators outperformed cells with 22 micron CSP separators and cells with 16 micron PE separators (“Control”) up to 2 C discharge rate (C-Rate) at temperatures of 0° C., 25° C., and 45° C. For example, the relative capacity at 2 C cycling at 25° C. for the 16 micron CSP cells and the 16 micron PE cells were 91% and 89%, respectively. As shown in this Example, the CSP-A cells displayed reasonably comparable performance to the control PE cells.

### Example 8

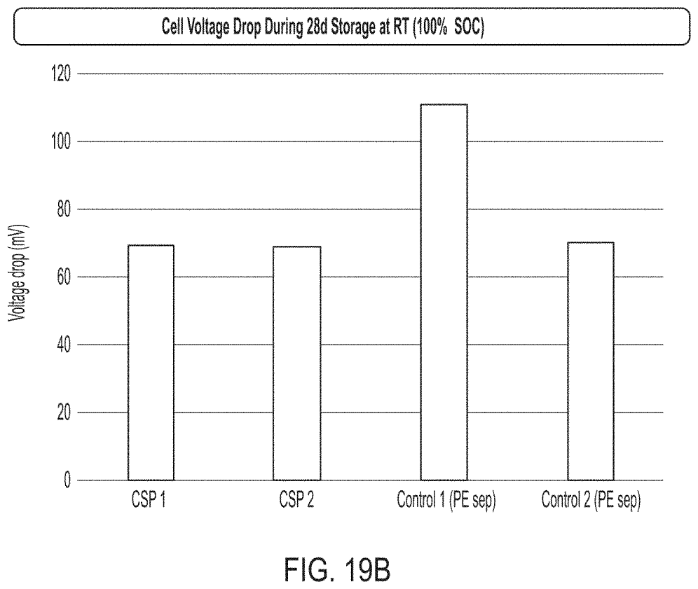

Various storage characteristics of cells incorporating CSP separators were evaluated. For a 28 day storage test, cells with 20 micron CSP separators (CSP-A version) were compared to cells incorporating 16 micron PE separators (“Control”). As shown in FIG. 19A, the CSP-separator cells exhibited improved capacity retention of about 96%, as well as retention consistency, over the Control cells at slightly below 95% capacity retention. Correspondingly, the CSP-separator cells also exhibited more consistency in minimized voltage drop of about 70 mV over a 28 day storage at room temperature and 100% state of charge (“SOC”), as shown in FIG. 19B.

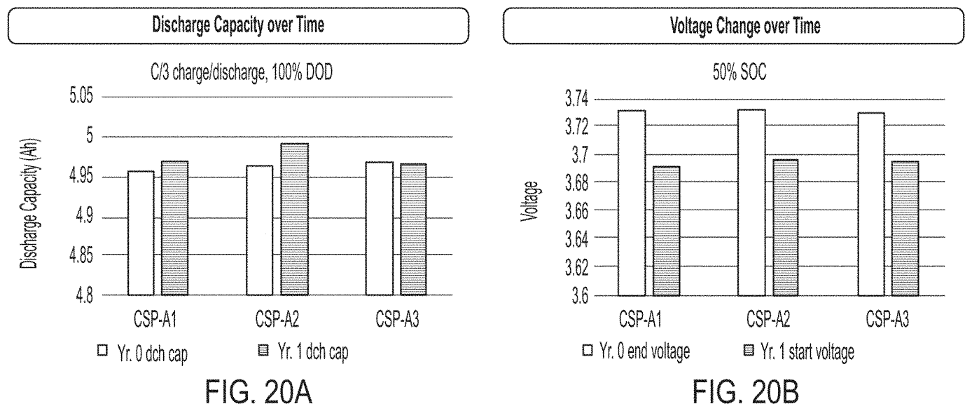

The CSP-separator (CSP-A version) cells were also tested for discharge capacity and voltage changes over storage at ambient conditions for over one (1) year, the results of which are shown in FIGS. 20A and 20B. As shown in FIG. 20A, the CSP-A separator cells retained their discharge capacity after the 1 year storage period, as shown by the discharge capacity measured by C/3 discharge/charge cycling before and after the 1 year. And, as shown in FIG. 20B, the CSP-A separator cells exhibited voltage drops of only approximately 30-40 mV at 50% SOC after the 1 year storage period from starting at 50% SOC at about 3.7 V.

### Example 9

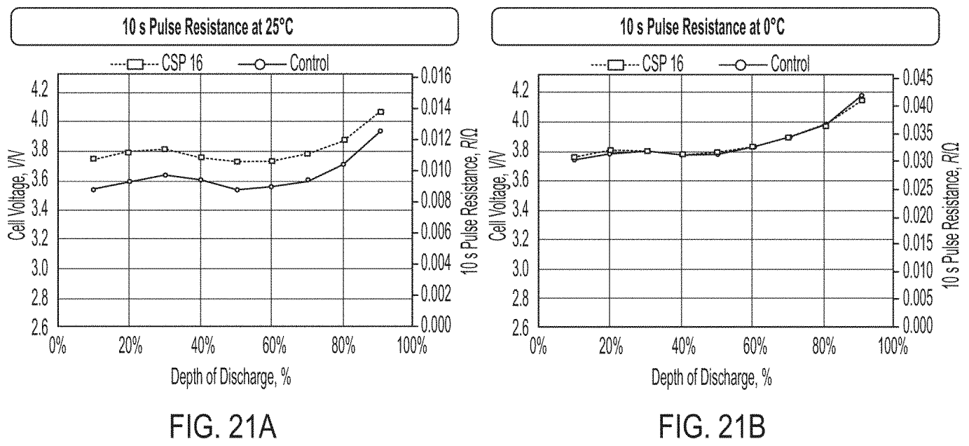

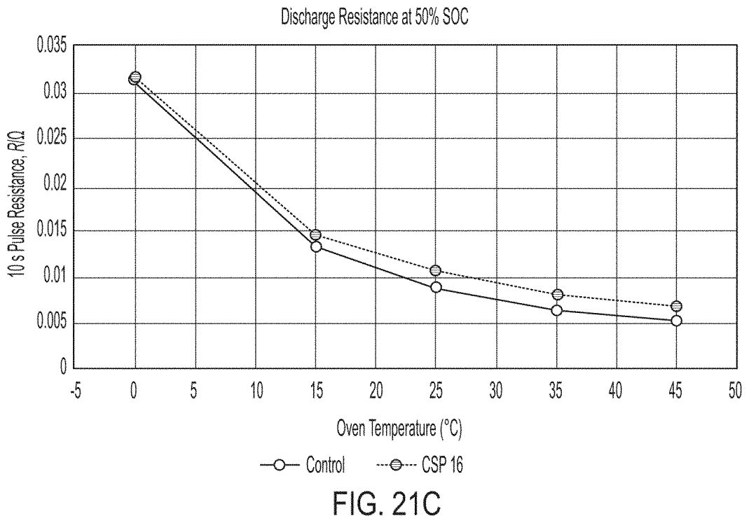

5 Ah pouch cells incorporating 16 micron CSP separators (CSP-A version) were evaluated for discharge resistance against 16 micron PE separator cells (“Control”) at 50% SOC using a 10 second pulse resistance method. For the discharge resistance testing in this Example, cells with the CSP-A version separator were used. As shown in FIGS. 21B and 21C, the CSP-separator cells showed comparable discharge resistance to the control cells at 0° C. At temperature ranges from 15° C. to 45° C., the CSP-A separator cells exhibited slightly higher discharge resistance, as reflected in FIGS. 21A and 21C.

### Example 10

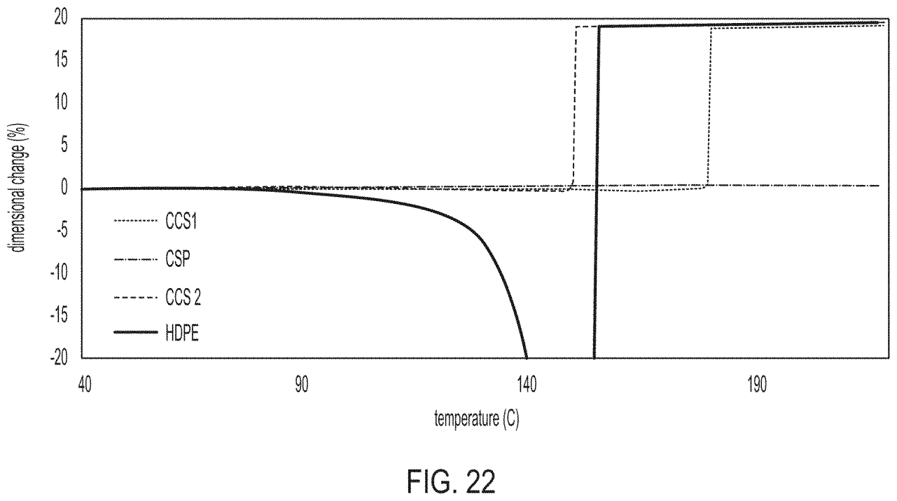

Thermomechanical analysis (TMA) was conducted on CCS, High Density Polyethylene (HDPE), and CSP separators (CSP-A version), respectively. The CCS samples were both one-side ceramic coated PE (CCS 1) and two-side ceramic coated PE (CCS 2). For the TMA conducted in this Example, a CSP-A version separator was used. As shown in FIG. 22, the CSP separator demonstrated dimensional stability with no shrinkage at temperatures up to 220° C., whereas the HDPE and CCS comparison samples all exhibited significant dimensional changes of 20% or more at lower temperature ranges below 190° C.

VI. Vacuum Drying (CSP-A)

As described above, in accordance with an exemplary embodiment of the invention, CSP-separator cells may be vacuum dried at an elevated temperature—in, for example, an unsealed pouch—before electrolyte filling for improved life cycle performance. In a preferred embodiment, the cells may be vacuum dried for approximately one (1) to four (4) hours at approximately 130° C. to 150° C., or at a temperature above 130° C. as long as the temperature and the time of the heating do not damage or degrade the anode, the cathode, the pouch casing material, or any other component of the dry cell before the filling with electrolyte.

### Example 11

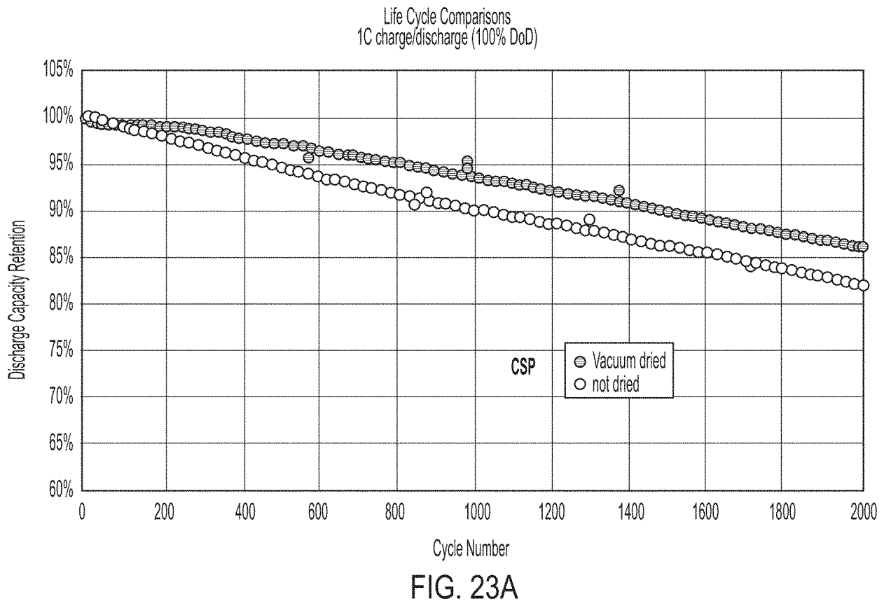

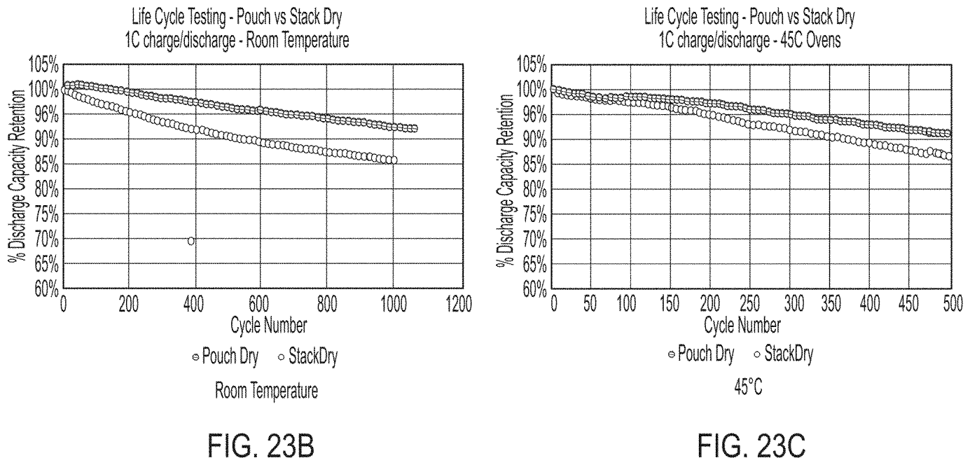

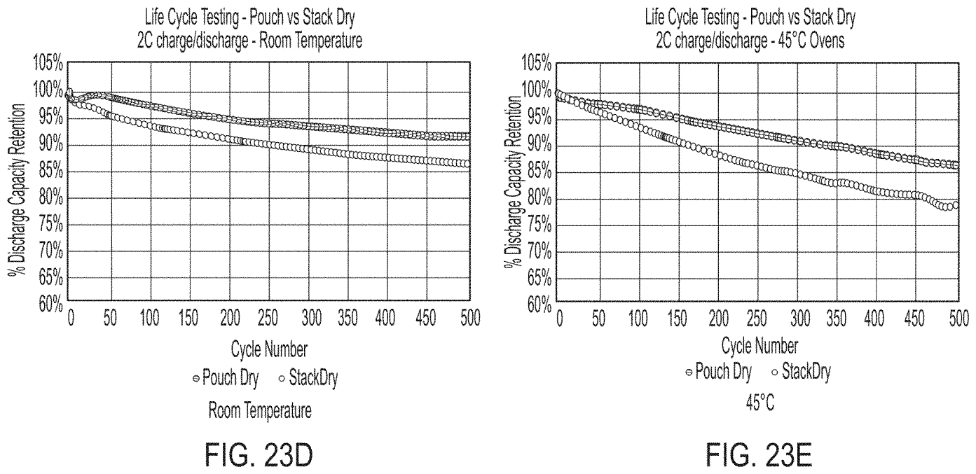

Life Cycle testing was conducted on CSP-separator cells that were undried, vacuum dried, and stack dried before electrolyte filling For the Life Cycle testing conducted in this Example, cells incorporating CSP-A version separators were used. As shown in FIG. 23A, cells that were vacuum dried at 130° C. for 4 hours showed notable improvement in discharge capacity retention above approximately two hundred (200) 1 C charge/discharge 100% depth of discharge (DoD) cycles, with an improved discharge capacity retention of 86% after two thousand (2000) 1 C charge/discharge 100% DoD cycles compared to non-dried cells at 82% capacity retention.

Additionally, as shown in FIGS. 23B and 23C, vacuum dried cells at 130° C. for 4 hours (CSP-A version in the pouch casing)—before electrolyte filling—exhibited improved discharge capacity retention over 1 C/C charge/discharge cycles at both room temperature and 45° C.—by about a 50% longer cycle life as estimated from 500 cycles at 45° C. with a 92% capacity retention, and from 1000 cycles at room temperature with a 93% capacity retention—in comparison to stack dried cells, which are dried after cell stacking and before being placed in the cell casing or enclosure—for example, a pouch. This improvement in cycle life for pouch vacuum dried cells compared to stack vacuum dried cells was confirmed by 2 C/2 C charge/discharge cycle tests at room temperature and at 45° C., the results of which are shown in FIGS. 23D and 23E. At room temperature, the pouch cells had a capacity retention of 91% after 500 cycles, compared to 86% capacity retention for the stack cells after 500 cycles. At 45° C., the pouch cells had a capacity retention of 85% after 500 cycles, compared to 78% capacity retention for the stack cells after 500 cycles.

### Additional Examples with CSP-B, CSP-B2, and CSP-B3

As described above, including in Table 1, all-ceramic free-standing separators may be formed by varying proportions of respective boehmite grades in the coating mixture. Separators from coating mixtures having the above-described CSP-B, CSP-B2, and CSP-B3 proportions have been shown to exhibit qualities suitable for use in lithium-ion cells and comparable to the results described herein for lithium-ion cells with the CSP-A separator.

### Example 12

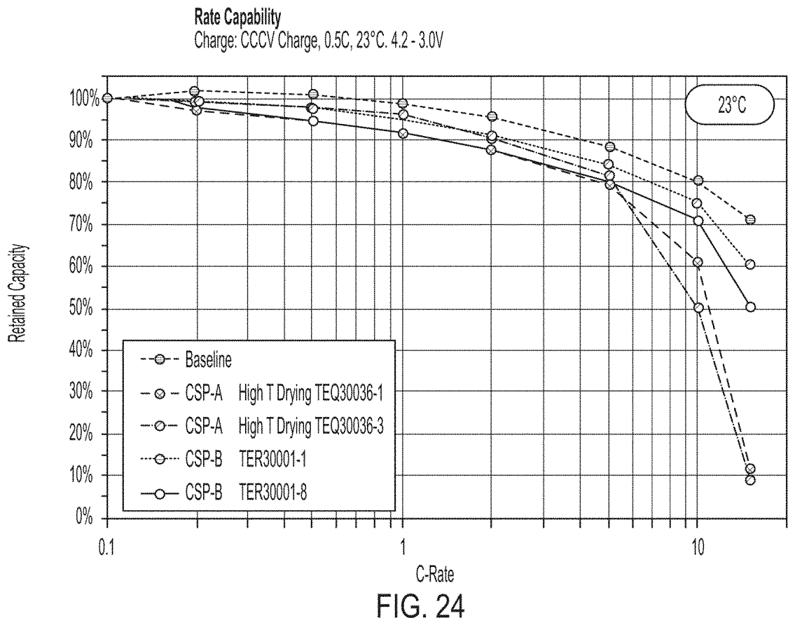

Cycling rate Capability testing was conducted on CSP-separator cells with CSP-A and CSP-B (as described above) version separators, respectively. FIG. 24 is a graph showing improved cycling rate capability for CSP-B separator cells over CSP-A separator cells at higher discharge rates at 23° C. at up to discharge rates of 20 C. At 10 C discharge rates, the retained capacity of the CSP-B separator averaged 73%, compared to retained capacity of 55% averaged for the CSP-A separator.

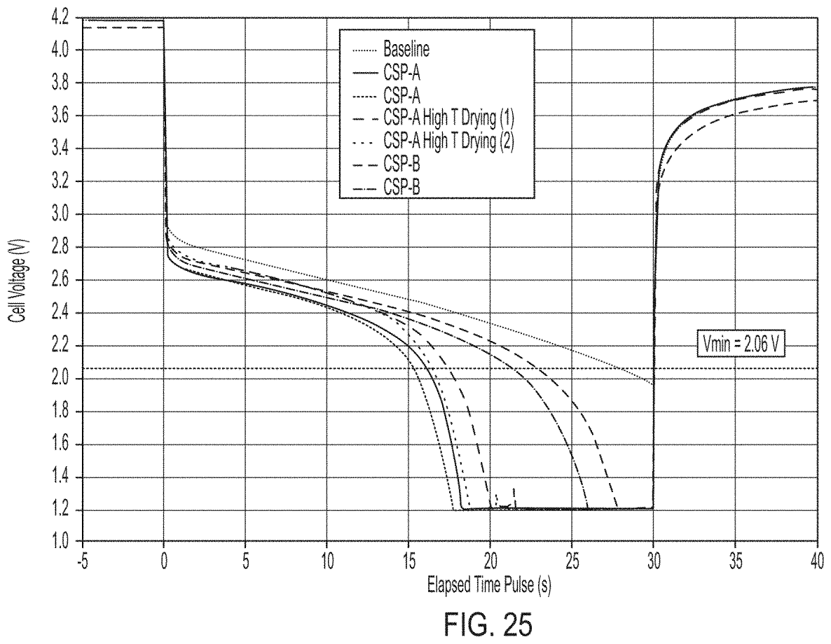

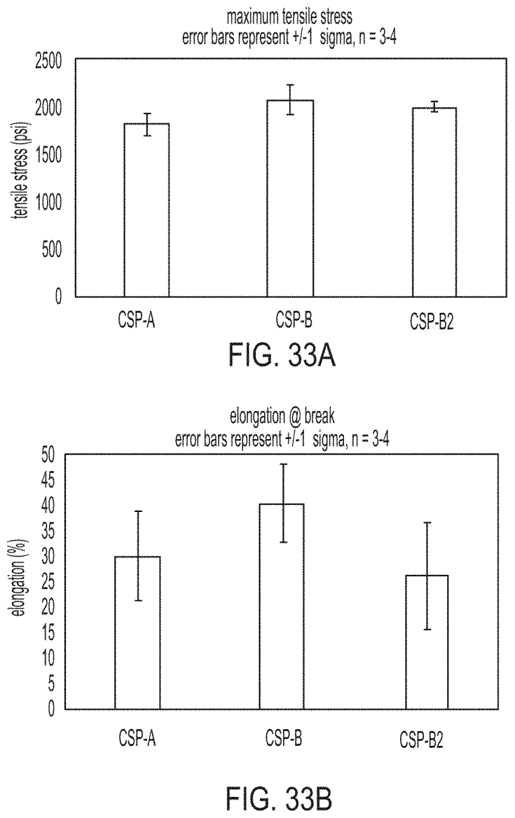

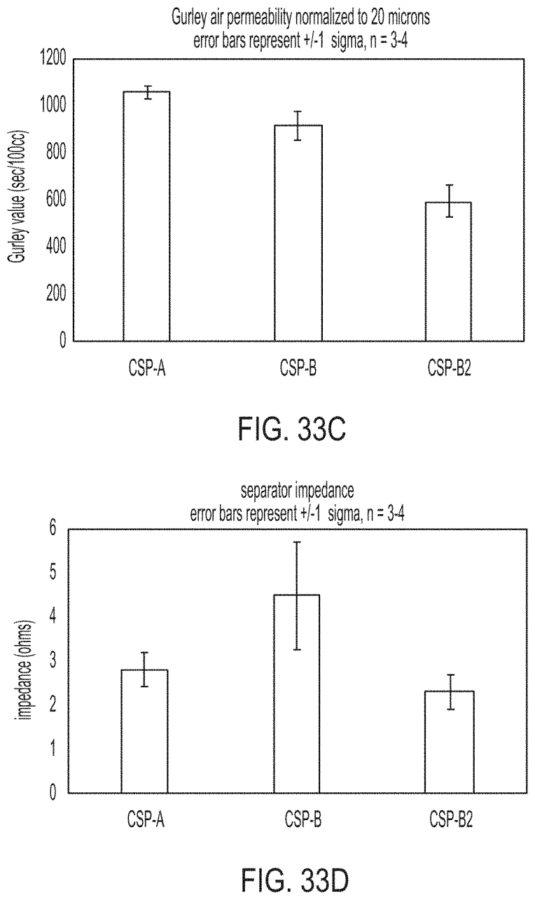

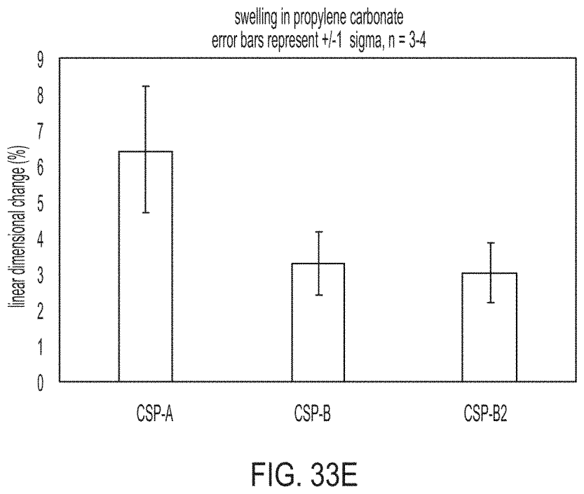

Correspondingly, cold crank amp (CCA) measurement testing was conducted on CSP-separator cells with CSP-A and CSP-B (as described above) version separators, respectively. FIG. 25 is a graph plot demonstrating the improved results for CSP-B separator cells over CSP-A separator cells. As shown in FIG. 24 and reflected in further detail in FIGS. 33C and 33D below, the CSP-B (and, in particular, CSP-B2) separators—with their larger average particle size, higher air permeability, higher porosity—exhibited lower impedance and improved capacity retention at high rates when compared to CSP-A separators.

VII. Vacuum Drying (CSP-B2)

As described above, in accordance with an exemplary embodiment of the invention, CSP-separator cells may be vacuum dried at an elevated temperature—in, for example, an unsealed pouch—before electrolyte filling for improved life cycle performance. In an exemplary embodiment, a free-standing CSP separator, or its precursor in roll form, may also be vacuum dried before cell fabrication for improved mechanical properties. Vacuum drying at elevated temperature affects the degree of crystallinity and, accordingly, the resultant mechanical properties. The vacuum state is important for moisture removal—and perhaps other volatiles, such as residual NMP and p-TSA. Additionally, an initial coating and drying process may provide for annealing a PVdF binder in the presence of the boehmite or other ceramic particles, which would result in enhanced mechanical properties during cell fabrication.

In a preferred embodiment, the separator (e.g., films 415a and 415b described above) may be vacuum dried for approximately one (1) to four (4) hours at approximately 130° C. to 150° C.

### Example 13

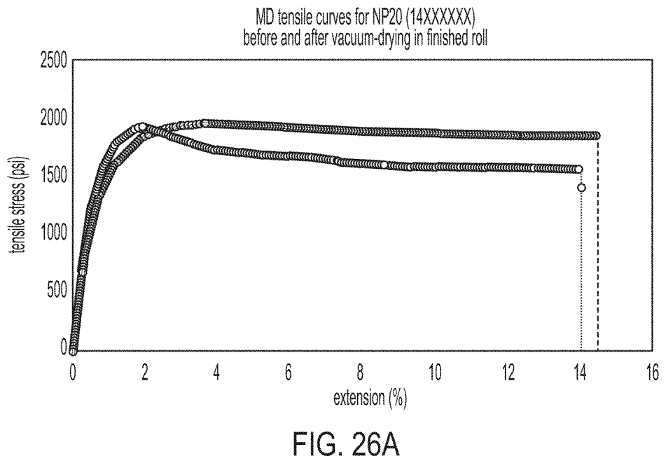

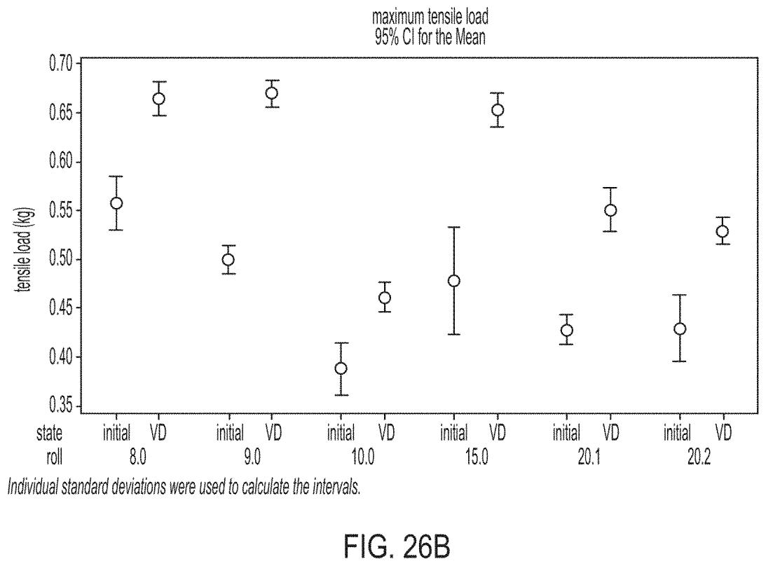

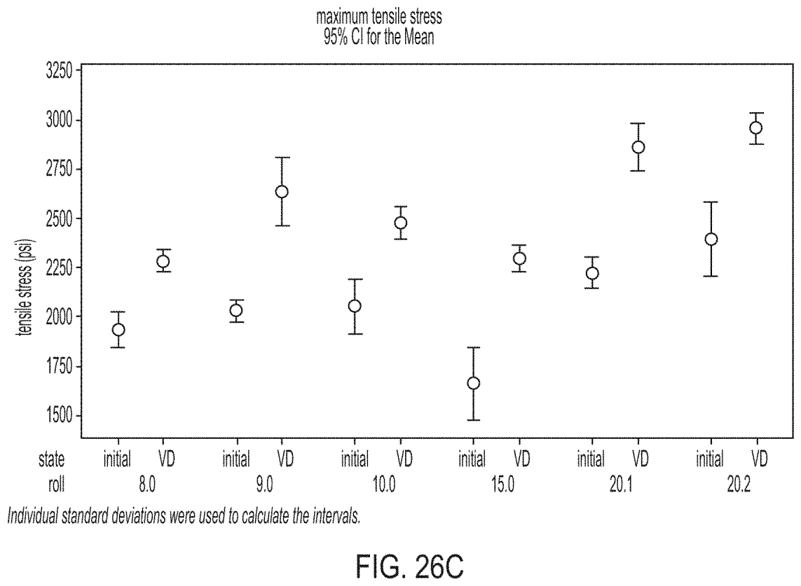

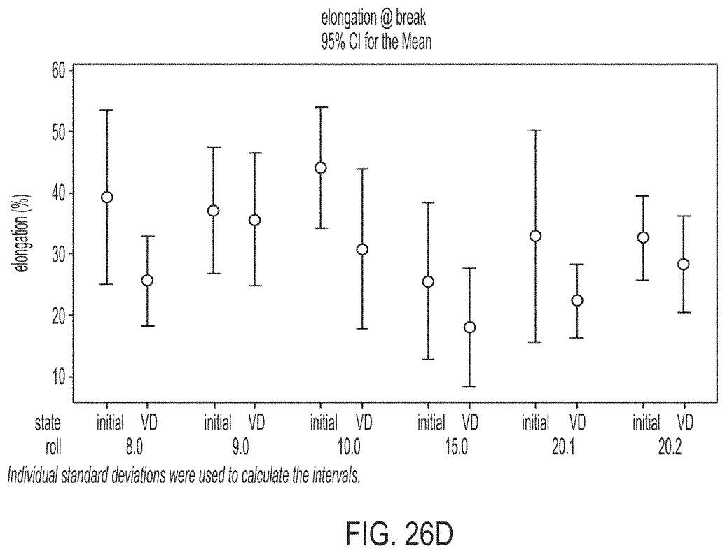

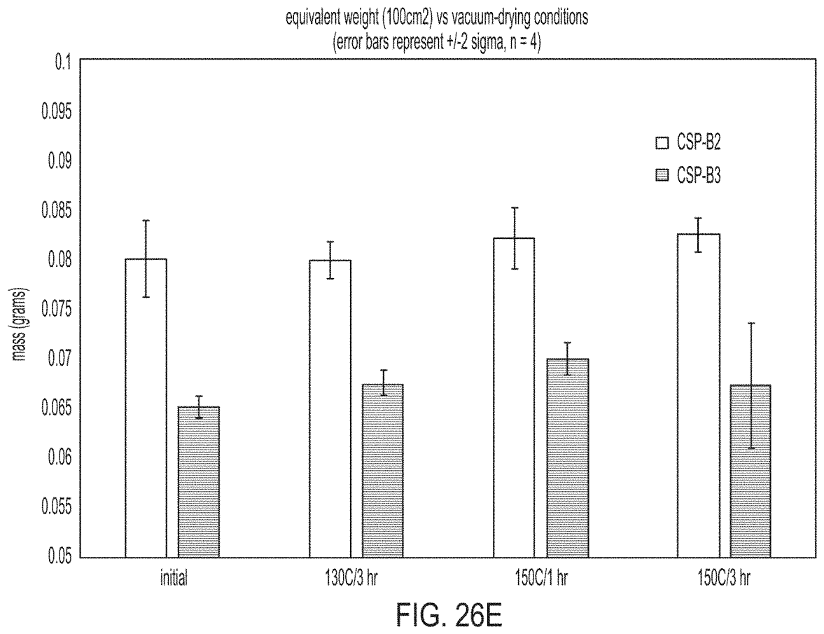

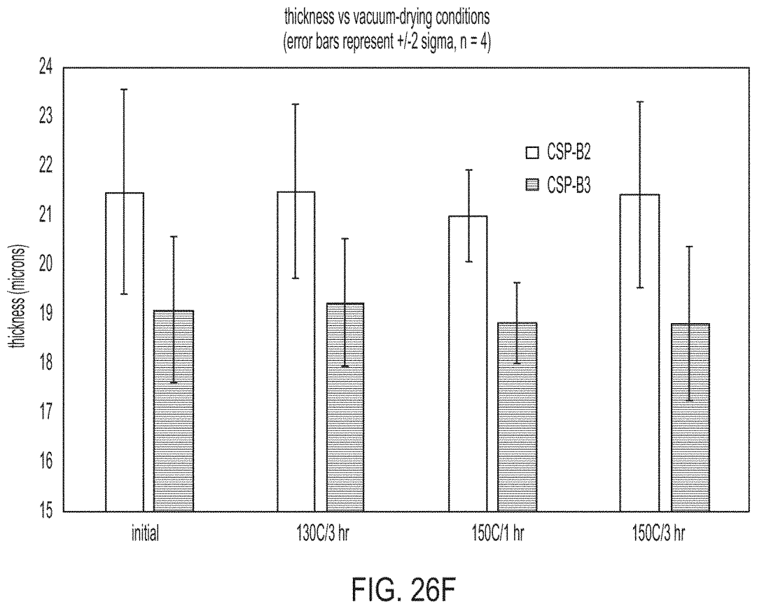

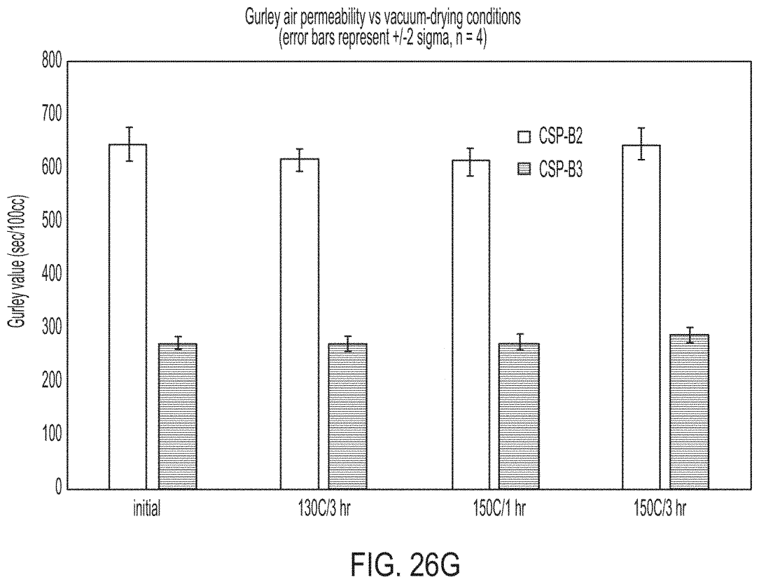

20 micron CSP-B2 samples were tested for mechanical properties before and after vacuum drying in roll form. FIG. 26A shows respective machine direction (MD) tensile curves for such samples before and after vacuum drying at 130° C. for 4 hours. Selective parameter results are summarized in Table 7 below.

TABLE 7

| | | 130° C./4 hrs |
|---|---|---|
| Property | Ambient | vacuum dry |
| maximum tensile | 1902 (61) | 1957 (48) |
| stress (psi) | | |
| tensile stress @ | 1892 (56) | 1829 (53) |
| 2% extension (psi) | | |
| elongation @ | 14.1 (5.9) | 14.4 (5.0) |
| break (%) | | |
| Est. fracture energy | 150.4 (62.7) | 181.7 (63.2) |
| modulus (MPa) | 2166 (276) | 1881 (192) |
| Gurley (sec/100 cc) | 960 (10) | 934 (17) |
| porosity via MOI (%) | 50.7 (2.0) | 47.3 (1.5) |
| PC uptake (wt %) | 44.8 (2.6) | 43.2 (2.2) |
| linear swelling (%) | 3.76 (1.74) | 2.75 (0.38) |

As reflected in FIG. 26A and Table 7 above, the physical properties of the CSP samples were improved via vacuum-drying in finished roll form. Maximum tensile stress increased, fracture energy/toughness increased, Gurley air permeability numbers decreased, and swelling in propylene carbonate (PC) decreased. The tensile stress numbers were about 10% higher for the vacuum dried CSP-B2 separator compared to the non-dried CSP-B2 separator. The swelling measurement in PC is done by soaking a 10 by 10 cm piece of the separator on a flat glass plate with PC and measuring the % swelling in the MD (machine direction) and CD (cross direction) directions on both edges after the 1 hour soak and averaging the four results. Soaking in PC provides an estimate of the % swelling when soaked in an organic electrolyte containing organic carbonate solvents and a lithium salt at about a 15% by weight concentration. Excessive swelling of the separator, such as greater than 5% swelling, when wet with organic electrolyte is not desirable and may cause problems in the yields and quality of the cell fabrication. These results on the CSP-B2 separator confirm improved mechanical properties and electrolyte swelling properties to better withstand stresses and separator alignment requirements attendant to cell fabrication processes.

### Example 14

Additional mechanical testing was conducted on CSP-B2, CSP-B3, and other films with the same blend ratio of boehmite particles, various pigment:binder proportions, and separator thicknesses, as summarized in Table 8 below, before and after vacuum drying, the results of which are shown in FIGS. 26B-26D.

TABLE 8

| section | pigment: binder | Thickness |
|---|---|---|
| 8 | 3.70:1 | 21.7 |
| 9 | 3.70:1 | 18.4 |
| 10 | 3.70:1 | 13.9 |
| 15 | 4.1:1 | 21.4 |
| 20-1 | 2.7:1 | 14.4 |
| 20-2 | 2.7:1 | 13.4 |

As shown in FIGS. 26B and 26C, all samples exhibited higher maximum tensile load in 0.75 inch wide separator samples and higher maximum tensile stress of about 20% to 30% to values in the range of 2300 to 3000 psi after vacuum drying (VD)—compared to their initial, pre-drying states (initial). This is an important benefit for the mechanical strength of the CSP. As shown in FIG. 26D, some samples showed a slight decrease in percentage (%) elongation at break after vacuum drying, but still had acceptable elongation of greater than 15% and typically 25% to 40% after the vacuum drying.

### Example 15

Additional testing was conducted on CSP-B2 and CSP-B3 samples before and after vacuum drying under various parameters. FIG. 26E shows the equivalent weight of such samples at the same area before and after vacuum drying for 3 hours at 130° C., 1 hour at 150° C., and 3 hours at 150° C., respectively. The CSP-B2 samples (or “G2 r2”) showed a slight increase in equivalent weight after vacuum drying at higher temperatures, while the CSP-B3 samples (or “G2 r3”) also showed a slight increase in weight after vacuum drying. These changes in weight are very small and within the range of experimental error, as shown by the standard deviation bars for each bar of data in FIG. 26E. FIG. 26F shows the sample thicknesses before and after vacuum drying. As illustrated in FIG. 26F, the CSP-B2 samples showed a slight decrease in thickness after a short, 1 hour, vacuum drying period, with the thickness returning to approximately its initial state after more prolonged drying, 3 hours. Correspondingly, the CSP-B3 samples showed a slight decrease in thickness after vacuum drying at higher temperatures. These changes is thickness as measured with a Dorsey gauge are very small and within the range of experimental error, as shown by the standard deviation bars for each bar of data in FIG. 26F. Finally, FIG. 26G shows the Gurley air permeability of the samples and they did not exhibit remarkable changes after vacuum drying. FIG. 26G shows that CSP-B3 (or “G2 r3”) with a Gurley number of about 280 seconds/100 cc of air has a significantly lower air permeability number and greater air permeability or porosity than CSP-B2 (or “G2 r2”) with a Gurley number of about 600 seconds/100 cc.

VIII. Calendering

In accordance with an exemplary embodiment of the invention, films 415a and 415b described above with reference to FIG. 4 may be subjected to calendering prior to cell fabrication for reduced thickness while preserving acceptable mechanical and electrical properties for use in a lithium ion cell. In an exemplary embodiment, films 415a and 415b may be calendered between upper and lower rolls against a polymer (e.g., PET) film substrate.

### Example 16

Samples of CSP-A, CSP-B2, and CSP-B3 films were produced as described above and cut before delamination to provide about 18 to 24 inch length sheets up to approximately 12 inches wide with the CSP layers still on the PET release substrate and were subjected to calendering while heating the bottom roll.

The samples were calendered in different configurations, “Up” means that the CSP side was against the upper, unheated roll, and the PET film side was against the heated bottom roll, and conversely, for “Down”.

The first experiments were run at a pressure of approximately 1500 psi (or about 1250 pounds per linear inch), with the bottom roll warmed to about 110° F. to about 140° F.

Sample (1) was a 20 micron CSP-B2, 3.75 pigment:binder (P:B). Samples (1), (1)A, and (1)B were calendered one pass in the “Up” orientation. The 20 micron starting CSP became more transparent with calendering with a thickness around 13 to 15 microns, which is about a 30% thickness reduction. Sample (1)C was two passes through the calender with the second pass being done from the opposite direction. The thickness appeared to be not significantly changed by the second calendering pass. Due to some non-uniformity in the calendering pressure across the width of the sheets, the transparentization of these samples was not uniform with one side being more transparent and there being partially transparent, partially less opaque areas in the samples.

Samples (1)D and (1)E were the 20 micron CSP-B2, and were run in the “Down” orientation. This gave less reduction in thickness to about 16 to 17 micron compared to the “Up” orientation. Sample (1)F was two passes but didn't appear to further reduce the CSP-B2 thickness.

Sample (2) was the 20 micron CSP-B3, 4.25:1 P:B. Samples (2) and (2)A were run in the “Up” orientation and gave a CSP thickness of about 16 to 17 microns. There was no significant change in thickness with two passes with Sample (2)B. Samples (2)C and (2)D were calendered in the “Down” position and gave a CSP thickness of about 17 to 18 microns. There was no significant change in thickness with two passes with Sample 2(E).

Sample (3) was the 12 micron (labelled 10 micron in Table 9) CSP-B2, 3.75:1 P:B. Samples (3) and (3)A were run in the “Up” orientation and gave a CSP thickness of about 10 microns. There was no significant change in thickness with two passes with Sample (3)B. Unlike the 20 micron CSP, there was some “pickoff” of the 12 micron thick CSP coating in places from the calendering operation. It appeared to be due more to an abrasion and tear of the thinner CSP, rather than to any adhesion of the CSP layer to the calender roll. There was no significant change in thickness with two passes with Sample 3(B). The thickness changes were the same on Samples (3)C and (3)D with one pass and on Sample (3)E with two passes.

Sample (4) was a CSP-A, 3.75 P:B of about 26 to 27 microns in thickness. Sample (4) was calendered in the “Up” orientation and gave a thickness of about 20 to 21 microns.

Sample (4)A was calendered in the “Down” orientation and also gave a thickness of about 20 to 21 microns.

The next calendering experiments were done at 750 psi, which is about 700 pli (pounds per lineal inch). This gave much less transparentization. Sample (1)G was calendered in the “Up” orientation and gave a CSP thickness of 16 microns. Sample (1)H was calendered in the “Down” position. Samples (2)F and (2)G were calendered in the “Up” and “Down” orientations, respectively. Samples (3)F and (3)G were calendered in the “Up” and “Down” orientations, respectively. Samples (4)B and (4)C were calendered in the “Up” and “Down” orientations, respectively.

The calender was then set to 250° F. (its maximum setting) for “hot” calendering. The temperature read-out was about 280° F. This temperature was too hot for calendering without distorting the base PET film. The following samples were run. Samples (1)I and (1)J were calendered one pass in the “Up” orientation and gave a CSP thickness of about 14 to 15 microns. There was no significant change in thickness with two passes with Sample (1)K. Other samples were run, but all had some distortion of the PET substrate. This indicates that the temperature of the calender rolls had been set too high for this set of experiments.

The above-described calendering conditions are summarized below in Table 9.

TABLE 9

| Test | | Separator Samples | | | |
|---|---|---|---|---|---|
| Conditions | | CSP-B2 | CSP-B3 | CSP-B2 | |
| (Temp/Nip | | (3.75:1; | (4.25:1; | (3.75:1; | CSP-A |
| Pressure) | orientation | 20 μm) | 20 μm) | 10 μm) | (20 μm) |
| RT/750 | Up | 1G | 2F | 3F | 4B |
| | Down | 1H | 2G | 3G | 4C |
| RT/1500 | Up | 1, 1A, 1B, | 2, 2A, | 3, 3A, | 4 |
| | | 1C (2x) | 2B (2x) | 3B (2x) | |
| | Down | 1D, 1E, 1F | 2C, 2D, | 3C, 3D, | 4A |
| | | (2x) | 2E (2x) | 3E (2x) | |
| 250 F./750 | Up | 1I, 1J, 1K | | | |
| | | (2x) | | | |
| | Down | | | | |
| 250 F./1500 | | | | | |

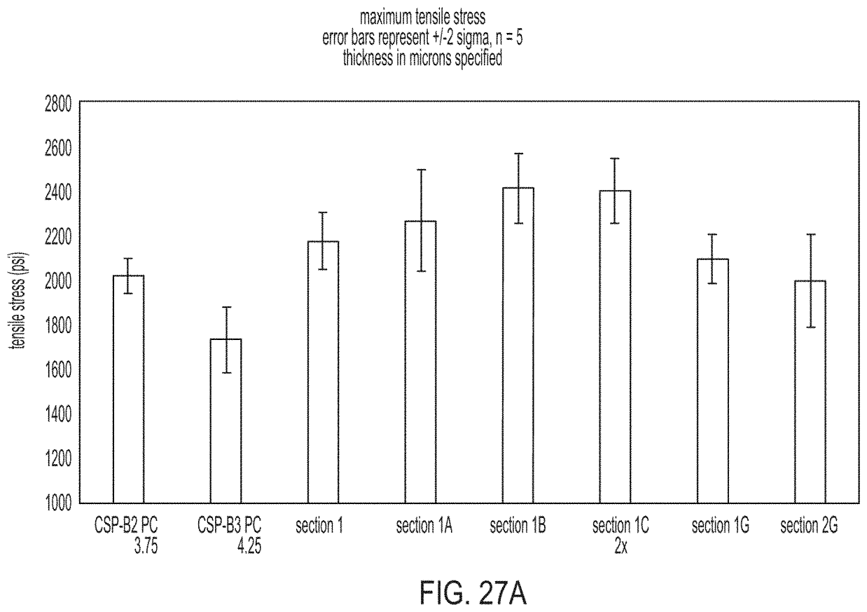

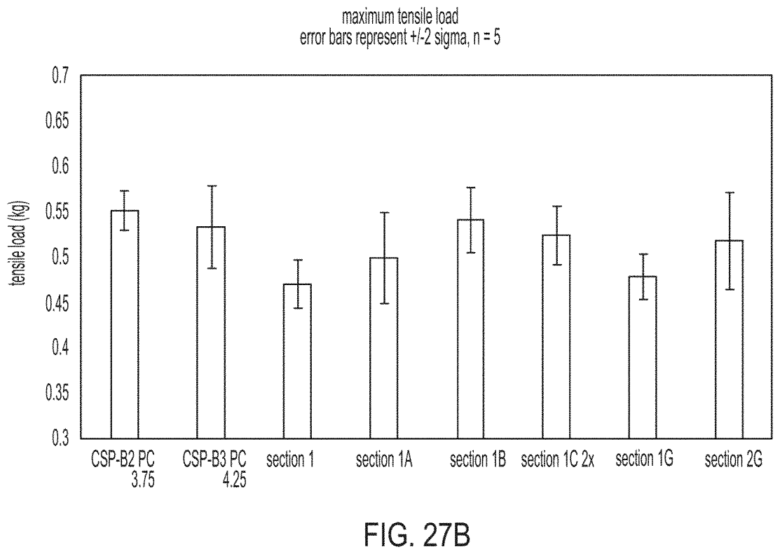

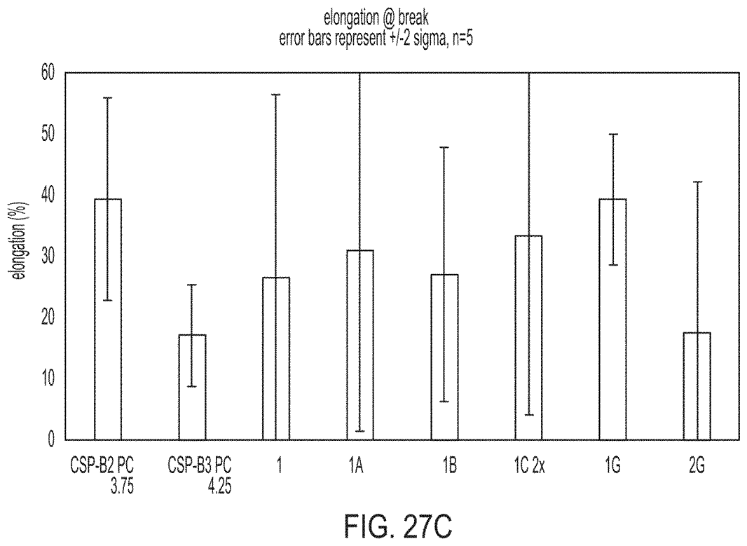

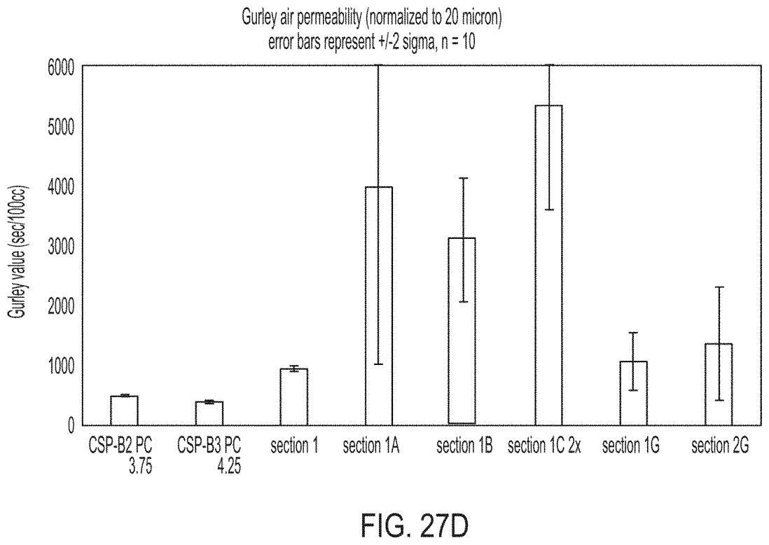

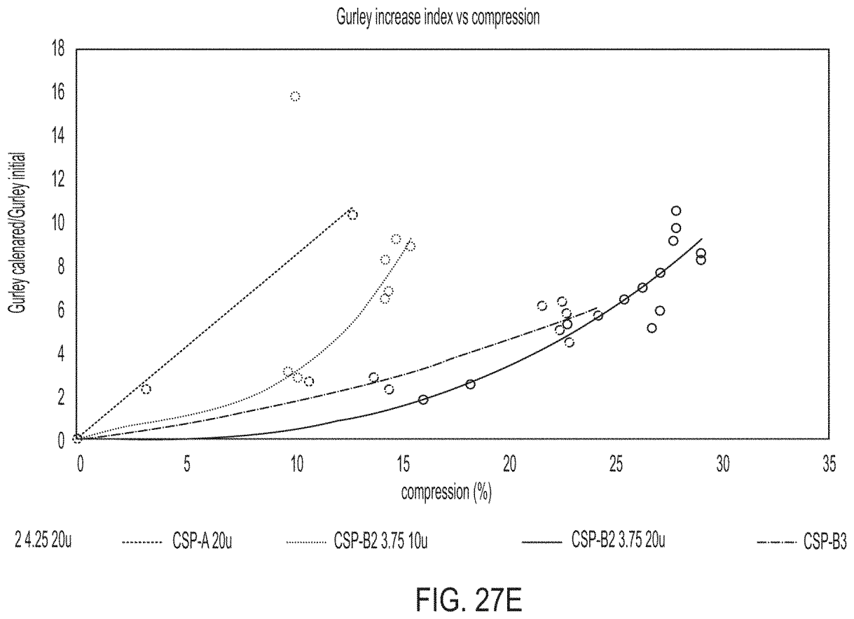

Samples (1, 1A, 1B, 1C (2×), and 1G) and (2G) in Table 9 were tested for mechanical properties and air permeability (Gurley), the results of which are reflected in FIGS. 27A-27E. As shown in FIG. 27A, Samples (1, 1A, 1B, and 1C (2×)) (CSP-B2 or “G2 r2” PC 3.75) exhibited about 10% greater maximum tensile stress (˜2200 psi) compared to a control sample, which is the uncalendered sample shown in the left-most bar in FIGS. 27A-27D. As also shown in FIG. 27A, Sample 2G (CSP-B3 or “G2 r3” PC 4.25) showed about 20% greater maximum stress at about 2000 psi compared to a control sample, which is the uncalendered sample shown in the second most left bar in FIGS. 27A-D. Both Samples (1B) and (2G) (CSP-B3 or “G2 r3” PC 4.25) showed comparable maximum tensile load (˜0.5-0.55 kg) for a 0.75 inch wide sample, as shown in FIG. 27B. It is important to note that the calendered samples are much thinner by about 5% to 30% so they have the major benefit of a reduced thickness while still providing a comparable tensile load to the uncalendered samples. As shown in FIG. 27C, Samples (1, 1A, 1B, 1C (2×), and 1G) showed elongation of approximately 25% to 40% at break compared to the control uncalendered CSP-B2 with a % elongation of about 40%. These results indicate that the calendering does not significantly reduce the elongation and flexibility of CSP-B2. As shown in FIG. 27C, Sample 2G of CSP-B3 had an elongation at break of about 15%, which is similar to the elongation of the uncalendered control CSP-B3 sample. Both Samples (1, 1 A, 1B, 1C(2×), and 1G) and (2G) showed relatively higher Gurley air permeability numbers in comparison to control samples. FIG. 27D illustrates, in more detail, the relative Gurley air permeability numbers among the CSP samples. These higher Gurley air permeability numbers after a high level of calendering are not expected to result in a corresponding lowering of the ionic conductivity due to the electrolyte causing the CSP to swell back towards its original state before calendering. These calendering results show that calendering provides another useful option for optimizing the trade-off between higher mechanical strength and higher % porosity of the separator. For example, CSP-B3 has less mechanical strength and higher porosity than CSP-B2, but CSP-B3 (or an even higher pigment:binder ratio but less mechanically strong versions of it) can be made mechanically stronger by calendering while still providing good porosity and ionic conductivity.

FIG. 27E illustrates the Gurley permeability against progressive compressions of various CSP-A (20 microns thick), CSP-B2 (12 and 20 microns thick), and CSP-B3 (20 microns thick) samples. As shown in FIG. 27E, at 10/o compression by calendering, the Gurley number for CSP-A was about 8 times higher than the value before calendering. The 20 micron thick samples of CSP-B2 and CSP-B3 at 10% compression had about 1.5 times or less of an increase in their Gurley numbers upon calendering. This is supporting evidence that the higher porosity and lower Gurley number CSP-B2 and CSP-B3 separator designs with their blend of a large and a smaller grade of boehmite particles lend themselves better than the CSP-A separator design to increasing mechanical strength by calendering and also to provide edge reinforcement and strength by compressing the edge areas of the separator.

IX. Cross-Linking

In accordance with an exemplary embodiment of the invention, a cross-linking coating material may be applied to a CSP film—for example, films 415a and 415b described above—prior to cell fabrication for enhancing mechanical properties of the resulting separator. The cross-linking coating may be a polyaziridine cross-linker, an isocyanate cross-linker, and the like.

### Example 17

Samples of CSP films (CSP-A and CSP-B2) applied with di- and tri-functional isocyanate cross-linkers incorporated into the CSP-A and CSP-B2 coating mixes were tested for mechanical properties.

Using CSP at 3.5:1 with Solef® 5130 as a baseline formulation (CSP-A version), Teracure® N33 (Desmodurg N3300)(tri-functional) and Desmodur® W (di-functional) at loadings of 0.375 phr (per hundred parts resin) and 0.75 phr, respectively, were utilized.

The samples were coated on a release coated SR²/SKC Skyrol® SH-400 PET liner substrate at a target dry coating thickness of 20 microns. Drying conditions were 400° F. for about 2 minutes and a linespeed of 5.5 fpm (feet per minute). A portion of each section was given a second pass through the coater under the same drying conditions.

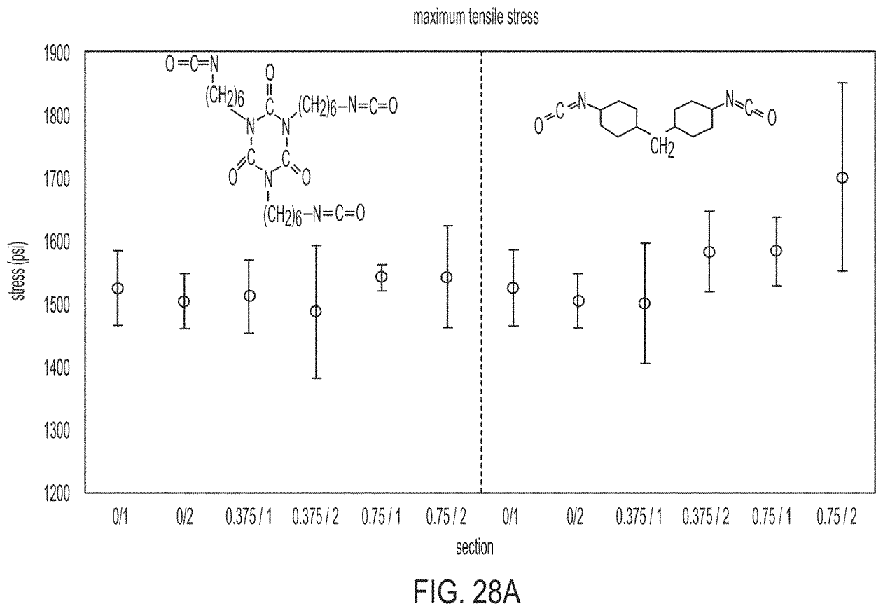

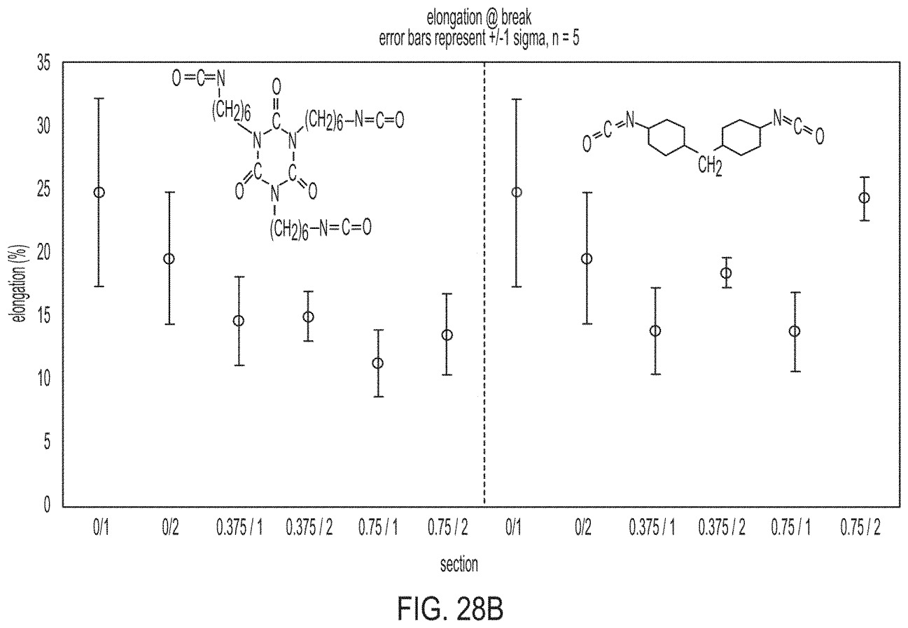

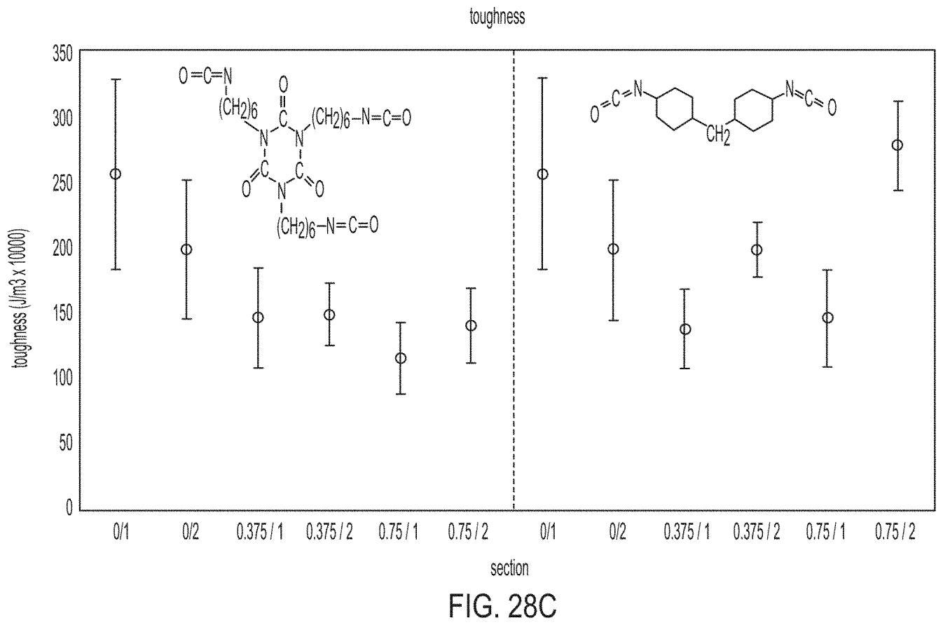

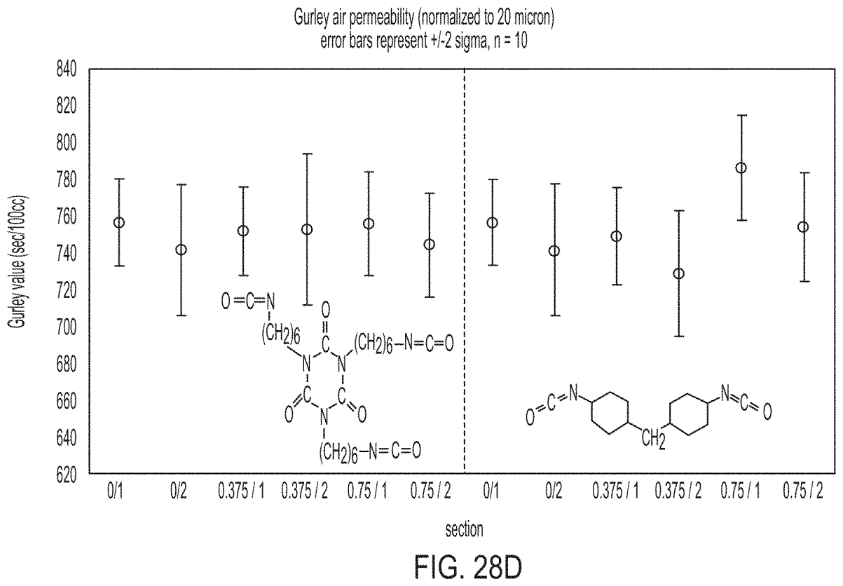

FIGS. 28A-28D respectively illustrate the maximum tensile stress (FIG. 28A), percentage (%) elongation at breakage (FIG. 28B), “toughness” (FIG. 28C), Gurley air permeability (FIG. 28D) of the cross-linker coated samples, with results for samples coated with a tri-functional isocyanate cross linker being shown on the left hand side of these figures along with the corresponding cross-linker molecule and samples coated with a di-functional isocyanate cross-linker being shown on the right hand side of these figures along with the corresponding cross-linker molecule. “Toughness” shown in FIG. 28C, or the energy per unit volume required to cause failure, is represented by the integrated area under the stress-strain curve for the respective sample. FIGS. 28A-28D illustrate results of samples according to cross-linker level/number of passes through the coater (1 or 2) on their respective x-axes. As shown in FIG. 28A, the trifunctional crosslinker at both additive levels and 1 or 2 passes resulted in no significant changes to the tensile stress value with no crosslinker of about 1500 psi with either 1 or 2 passes through the coater and its oven. In contrast, the difunctional crosslinker with 2 passes at the lower additive level or 1 pass through the coater oven at the 2× additive level increased the tensile stress value to about 1600 psi. Doing both the 2× additive level and 2 passes through the coater oven further increased the tensile stress value to about 1720 psi.

As shown in FIGS. 28A-28D (left hand side), tri-functional cross-linker (Desmodur® N3300) samples exhibited no significant increase in tensile strength and elongation/ductility decreasing with loading of the crosslinker. Correspondingly, di-functional cross-linker samples exhibited a more pronounced increase in tensile strength with loading of the crosslinker and a lower reduction in elongation with loading relative to tri-functional cross-linker samples. Furthermore, additional heating (second pass through coater) resulted in a distinct increase in elongation/toughness for these sections with the difunctional crosslinker with, for example, the % elongation at break with the 0.75 phr of crosslinker and the two passes through the coater oven being the same, at about 25%, as the control CSP-B2 with no crosslinker. In addition, cross-linker loading and additional drying had minimal effect on the Gurley air permeability numbers for either crosslinker.

The results imply that mechanical properties of standard CSP separators—i.e., 3.5:1 pigment:binder (P:B) ratio with no cross-linker—may be matched using 4.0:1 pigment:binder ratio with a di-functional cross-linker, while also attaining much lower Gurley values and, perhaps, higher porosity.

### Example 18

CSP-B2 (or “G2 r2”) samples coated with a Desmodur® RE Series cross-linker of the following formula were also prepared for testing:

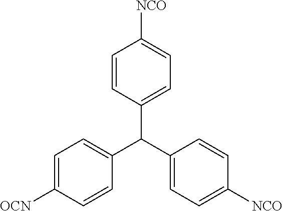

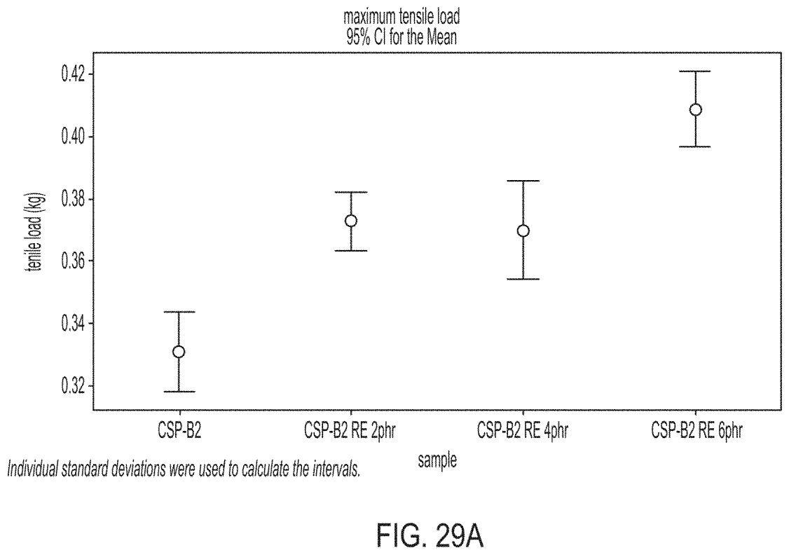

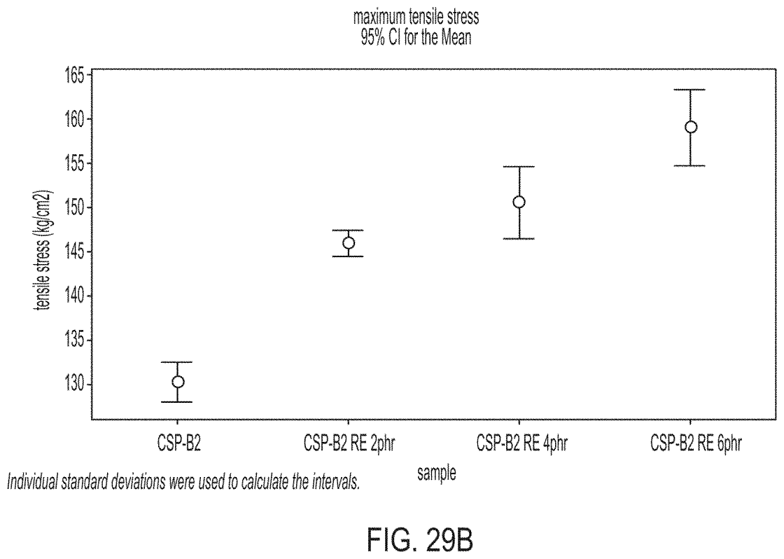

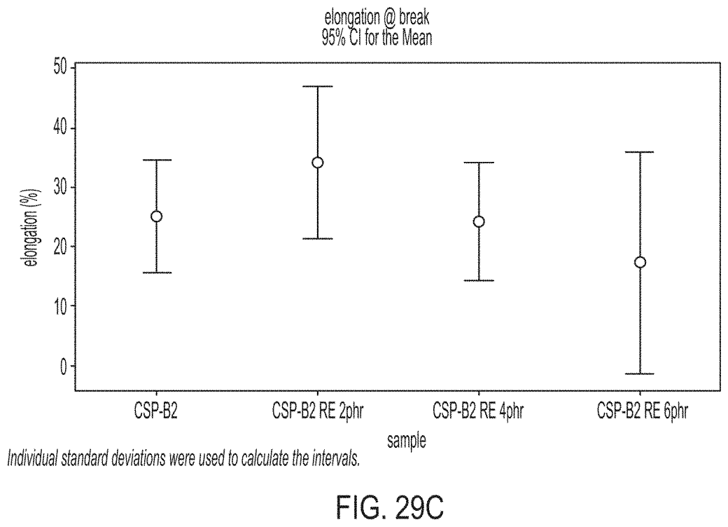

FIGS. 29A-29C show mechanical testing results of the samples. As shown in FIGS. 29A and 29B, over a range of 0 phr on PVdF binder to 6 phr on PVdF binder, the samples showed a monotonic increase in initial tensile strength of resultant films. FIG. 29B shows that the tensile stress of CSP-B2 (or “G2 r2”) increases from about 130 kg/cm² to about 145 kg/cm² at a 2 phr loading of the crosslinker, to about 150 kg/cm² at a 4 phr loading, and to about 160 kg/cm² at a 6 phr loading. On the other hand, FIG. 29C shows a maximum in elongation at break of about 32% at 2 phr loading, which implies loading as a factor in optimization for “toughness”—i.e., a combination of tensile strength and ductility/elongation at break—as described above.

The reduction in ductility may be associated with increased fragility of the system (common upon cross-linking of polymers) or introduction of additional “point defects”—e.g., gels or boehmite aggregates—with higher loadings of the RE cross-linker. At the same time, as shown in FIG. 29C, the elongation of about 18% at 6 phr loading is only slightly below the % elongation at break for CSP-B2 with no crosslinker of 24%, with the 4 phr loading showing no significant difference also at about 24%.

### Example 19

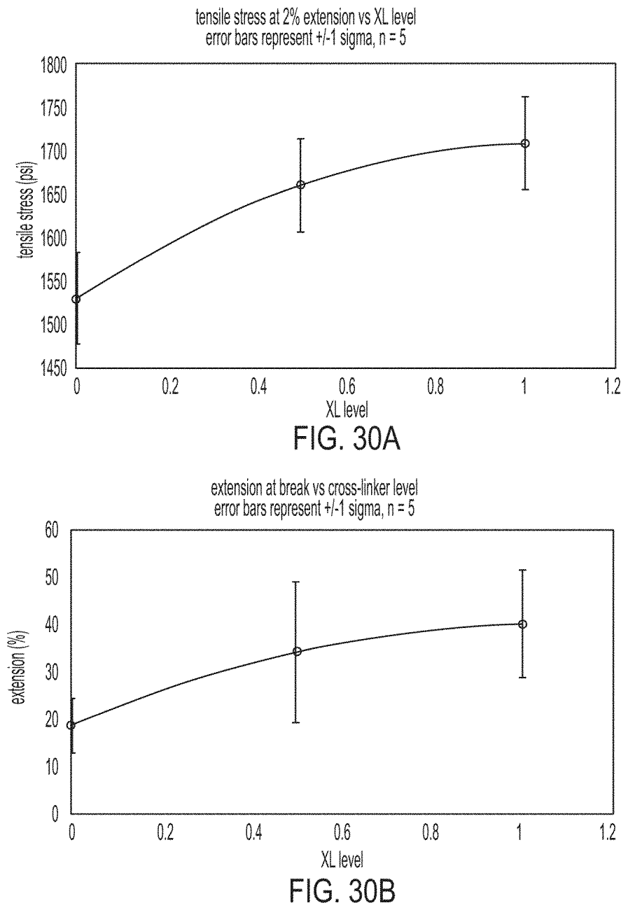

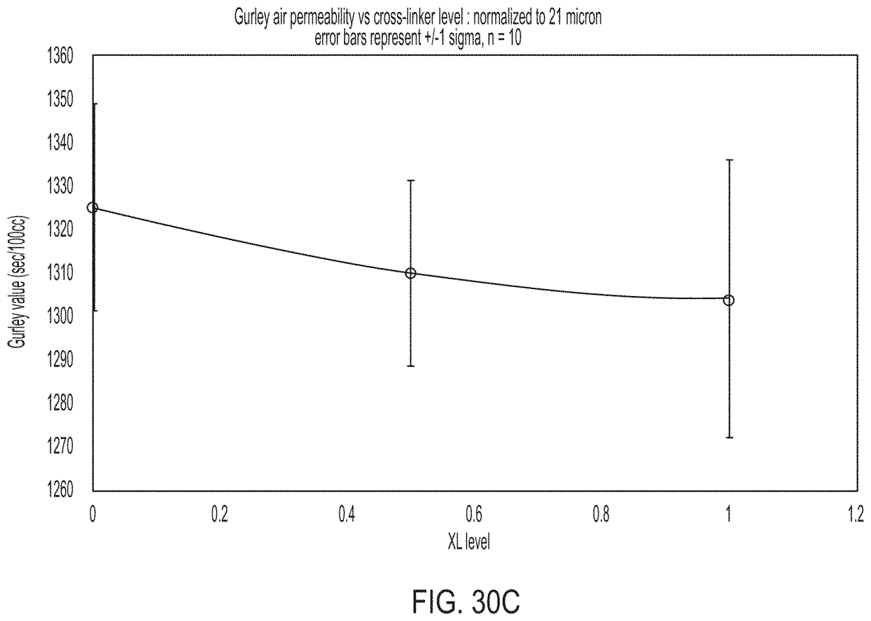

CSP-A samples coated with a polyaziridine cross-linker (PZ-33-pentaerythritol tris (3-(1-aziridinyl) propionate or PZ-28-trimethylolpropane tris(2-methyl-1-aziridine propionate)) were prepared and tested for mechanical properties, the results of which are reflected in FIGS. 30A-30C. As shown in these figures, the samples demonstrated improved “toughness” with minimal effect to the Gurley air permeability numbers. As shown in FIG. 30A, adding 0.5 phr and 1 phr of a polyaziridine crosslinker increased the tensile stress of the CSP-A separator with no crosslinker from 1540 psi to 1650 psi and 1700 psi, respectively, and, as shown in FIG. 30B, increased the % elongation at break of the CSP-A separator with no crosslinker from 20% to 34% and 38%, respectively.

X. Edge Reinforcement

In accordance with an exemplary embodiment of the invention, an edge reinforcement coating may be applied to a CSP film—for example, films 415a and 415b described above—in narrow lanes where there will be subsequent slitting to provide the CSP rolls at the desired width, or after the CSP is slit to size and prior to cell fabrication, for reinforcing the edges of the film and improving tear resistance and mechanical strength properties. The edge coating may be a UV-cured material, a chemically cross-linked material, a strong and flexible polymer material, and the like. For additional tear resistance and mechanical strength, this edge coating may be combined with compression of the CSP in the edge areas either prior to slitting or after slitting.

### Example 20

A polyethylene glycol diacrylate/pentaerythritol tetraacrylate (72:25) blend was applied to a “standard” CSP-A sample at various coating deposition weights using a #3 Mayer rod with MEK (methyl ethyl ketone) solutions of varying solids. For testing purposes, the samples were coated at full coverage, instead of coating in a narrow lane for providing an edge reinforcement lane after slitting. Although an oligomer/monomer blend was applied as a solution from MEK, the coating may be applied at 100% NV. MEK solutions were used for this experiment to reliably control coating deposition weight and wettability of substrate. Coatings were dried in an oven at 100° C. for 60 seconds to remove the MEK. Resultant coated separators were then exposed to one pass through a Fusion UV system (H bulb, 20 ipm). From each coating sample, a single 100 cm² sample was taken; and basis weight (mass/area) and thickness (4×/sample) were measured.

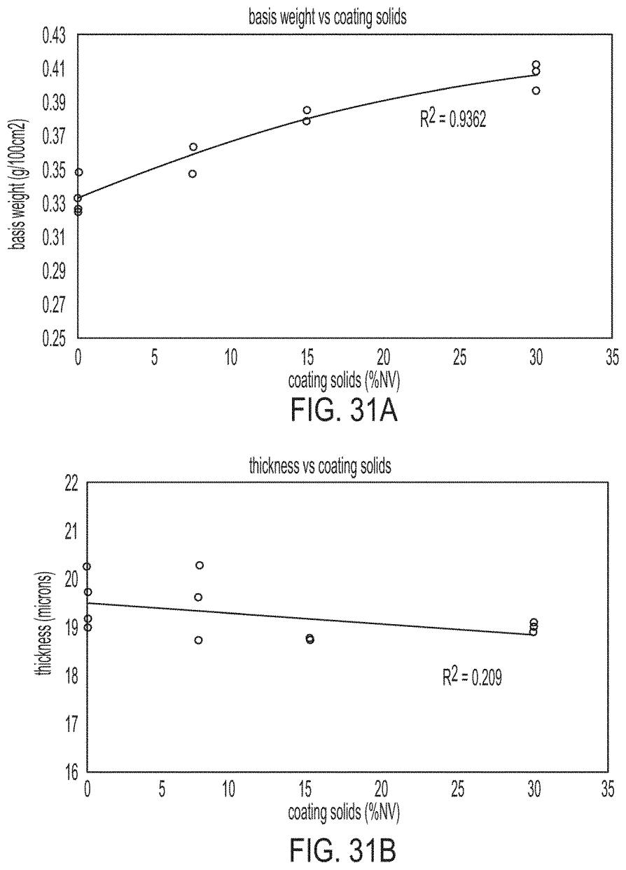

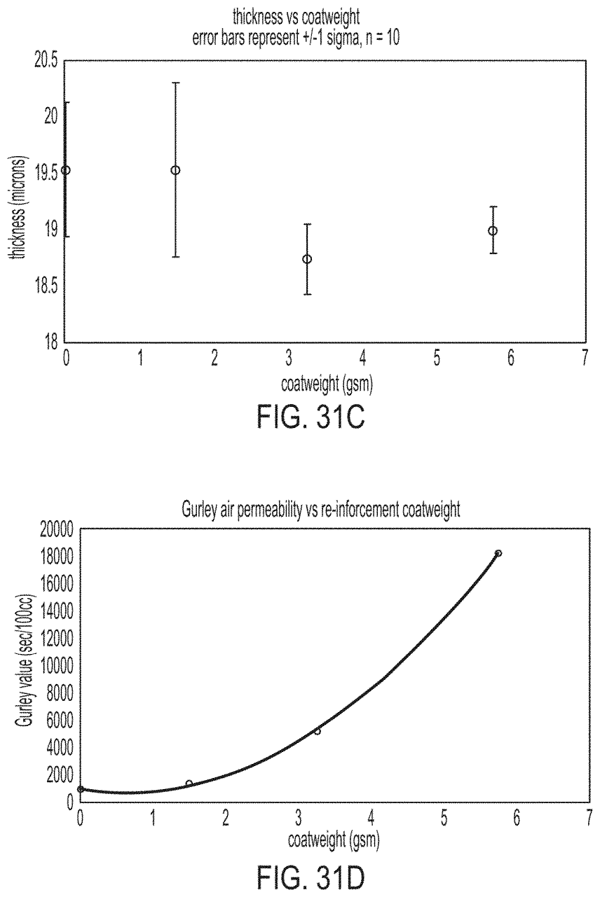

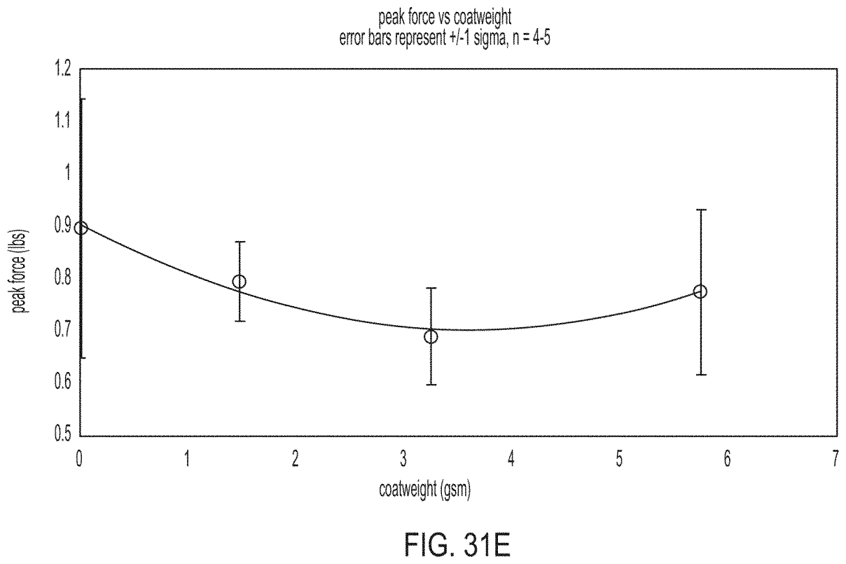

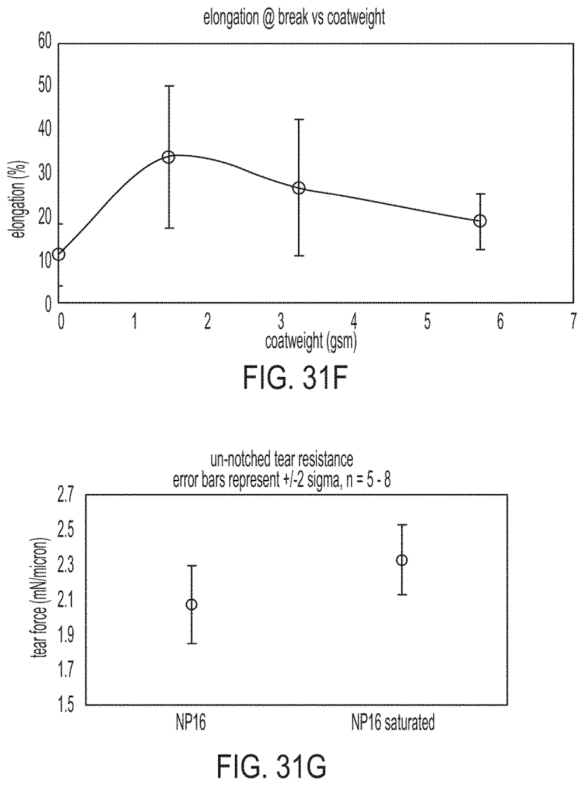

FIGS. 31A and 31B respectively show the basis weight and thickness against coating solids (in % NV) for the samples. As shown FIG. 31A, basis weight increased up to 8 grams per square meter (gsm) with increasing coating solids, as expected. However, as shown in FIG. 31B, thickness did not increase with coating solids over the range of formulations utilized (using a #3 rod for deposition), implying that the coating was imbibed in the pores of the separator, as desired. In other words, the testing showed that it would be feasible to improve separator edge tear resistance and mechanical strength properties without significantly affecting the thickness profile of the separator. An increase in the thickness at the edges from a buildup of more material on the edges would have a negative effect on the ability to wind long 500 meter and greater lengths of slit separator rolls without ending up with built-up, thicker, and possibly split and damaged edges.

### Example 21

Additional testing on edge reinforcement coating was conducted by coating a radiation-curable formulation (PEGDA/ethoxylated-TMPTA, 75:25, at various % NV [20%-40%] in MEK) on “standard” CSP-A (P:B=3.5:1, 20 micron) samples at full coverage. The samples were, thereafter, submitted to thermal drying (120 seconds @ 110 C) and UV-curing (single pass through Fusion unit, 20 ipm)

As shown in FIG. 31C and corresponding to FIG. 31B, thickness did not increase with coatweight; thus implying the UV-curable coating was being imbibed into the pores and dried and UV-cured in the pores. In addition, thickness measurements at higher coatweights suggested a slight reduction of thickness from about 19.5 microns to 19.0 microns at about 6 gsm, possibly a slight “densification” of the separator associated with shrinkage of the chemistry during polymerization.

FIG. 31D illustrates that the Gurley air permeability number increased significantly with increasing coatweight, but this increase did not become significant until above 2 gsm of coating. Since the narrow lanes of the reinforced edges, such as 2 to 4 microns on one or both edges of the separator, are all or mostly outside the active electrode and electrolyte stack of the cell, the edge reinforcement areas do not need to be porous so that the lithium ions can diffuse through them during cycling. Thus, it is acceptable for cell performance if these areas of the separator are totally filled with strong reinforcement material and, in fact, it is preferable since these edge areas are often free-standing at the edge of the cell stack and are exposed to stresses from the casing and during cell assembly and need to be as strong and flexible as possible. FIG. 31E shows that tensile stress at break decreased slightly with increasing reinforcement coatweight but, as reflected in FIG. 31F, elasticity improves dramatically with addition of the reinforcement chemistry, going from about 10% elongation at break through a maximum of about 30% elongation at fairly low deposition levels of 1.5 phr. FIG. 31G illustrates respective un-notched tear resistances of 16 micron CSP-A samples with (“NP16 saturated”) and without (“NP16”) edge reinforcement coating of about 2.3 mN/micron and about 2.1 mN/micron, respectively. As shown in FIG. 31 G, the coated samples showed a notable improvement in tear resistance.

It is very important to note that the edge reinforcement layers of the CSP need to be only about 2 to 4 mm wide and, as such, these edges are outside of the electrode areas, as the separators are wider than the electrodes in lithium ion batteries to protect against short circuits when the highly insulating separator is not present. Because of this, there is no or very little effect on the energy capacity and cycling of the cells if these edge areas of CSP are partially filled or completely filled with a toughening material for more mechanical strength. It is still important that these edges be not thicker that the rest of the CSP since this would cause problems in winding slit rolls of CSP that are often up to 2,000 meters in length. The above results show that the edge reinforcement materials can be imbibed into the high porosity CSP layer without adding to the thickness on the edges.

XI. Non-Swelling Layer

As described above, PVdF may be used as a binder material for forming free-standing CSP separators. One desirable feature of PVdF is its stability up to 5V in lithium ion and lithium metal cells. However, very high molecular weight PVdF, such as Sole®5140, swells by approximately 20% to 50% in electrolyte solvents, which may be advantageous for electrolyte wetting and for lower impedance but can result in too much swelling for a CSP separator. The inorganic materials in the CSP reduce to some extent the swelling of the PVdF. To avoid excessive swelling of inorganic/organic composite separators in electrochemical cells, where the organic polymer and the separators may swell a few percentages in the presence of the organic electrolyte, one or more non-swelling porous layers may be added to the composite separator to reduce the swelling to an acceptable level. This multi-layer approach also has the benefits of: (1) reducing the likelihood of pinholes by going from a single separator layer to multiple separator layers, where it is less likely to have a pinhole through the multiple layers; and (2) providing a non-swelling layer that may have other useful properties, such as safety shutdown, inhibition of the migration of transition metal ions, and increased mechanical strength. The one or more non-swelling layers may be formed by inorganic oxides, inorganic nitrides, and the like, and may comprise a polymer, which may be insoluble in water or other solvents, such as propylene carbonate and the like, such as, for example, a polyvinyl alcohol (PVA) that is insoluble in propylene carbonate and also does not swell in propylene carbonate. As another example, the polymer may have approximately 150 nm diameter water-insoluble polymer latex particles, such as products under the tradenames of Lumiflon® and Joncryl®. As described above, one or more layers of the CSP separator may comprise a crosslinking agent that reacts with the polymer particles.

In an exemplary embodiment, the one or more non-swelling layers are intermediate between an inorganic/organic composite layer on both sides, i.e., in a “sandwich” configuration. This has the advantage of protecting the intermediate, non-swelling layer from direct interaction with the surface of one of the electrodes to provide better consistency and long term performance in the cell. Other configurations may also be used to incorporate one or more non-swelling layers, for example:
(1) one non-swelling layer and one PVdF swelling layer;
(2) non-swelling layers on both sides of a PVdF swelling layer;
(3) two CSP layers laminated together with a non-swelling layer in the center;
(4) adding edge reinforcement lanes to configurations (1), (2), and (3) above by doing extra compression or calendering of lanes where the separator would later be slit.

In an exemplary embodiment of the invention, a CSP separator incorporating one or more non-swelling layers, as described above, may have reduced swelling of approximately 3% to 4%, or preferably less than 1% to 2%, or more preferably less than 0.5%, when soaked in propylene carbonate or in an organic electrolyte for 1 hour. Swelling tolerance may be increased for cylindrical or metal prismatic cells, where the separator is very constrained in a metal case when the electrolyte is added, whereas the benefits of reduced swelling may be more significant for pouch cells, where the case is a metalized plastic.

### Example 22

Samples of a non-swelling microporous layer were formed by non-solvent induced phase inversion of polyamide (Elvamide® 8063)/polyvinylbutyral (Butvar® B-98) blends. A seven (7) micron thick non-swelling layer of various blends was laminated between two 3.5 micron thick CSP-B2 layers.

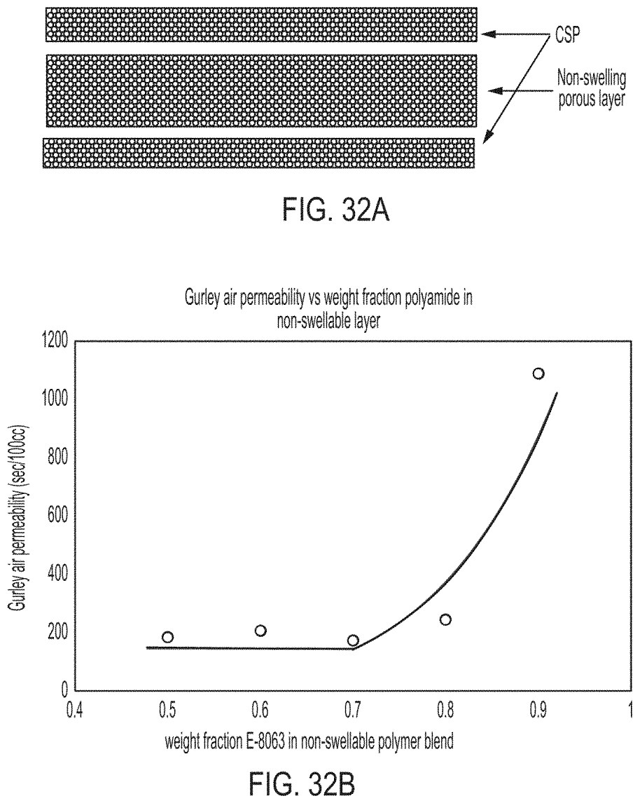

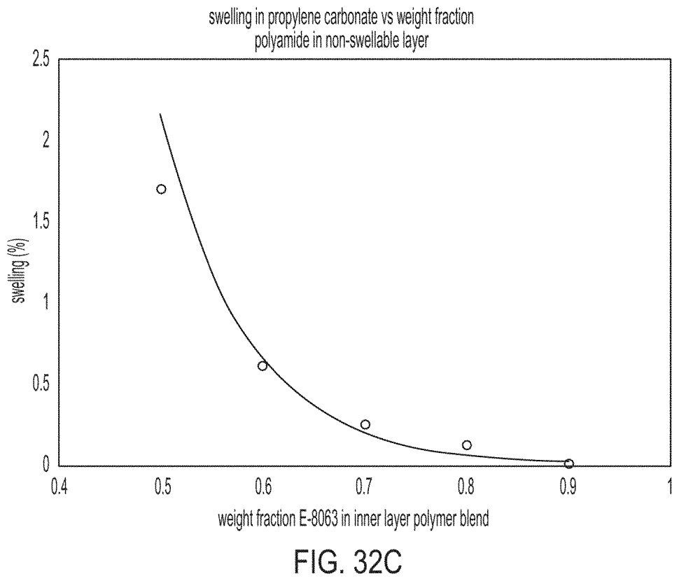

FIG. 32A illustrates a cross-sectional view of the layer structure among the non-swelling porous layer and the CSP-B2 (“CSP”) layers, where the CSP layers are on both sides of the separator with the non-swelling porous layer in the center. FIG. 32B is a graph showing the relationship between the Gurley air permeability number of the resulting laminate samples and the weight fractions of the non-swelling layer blends. Correspondingly, FIG. 32C is a graph showing the relationship between the percentage (%) swelling of the laminate samples and the weight fractions of the non-swelling layer blends. The low Gurley number is maintained up to a weight fraction of 0.7 for the E-8063 polyamide in the non-swellable polymer blend. As shown in these figures, the non-swelling layer made by a phase inversion method was effective in reducing swelling in propylene carbonate, which is representative of the solvents in a non-aqueous electrolyte—and resulted in a reduced Gurley air permeability number of slightly under 200 seconds/100 cc.

### Example 23

Samples having a corresponding CSP-non-swelling layer-CSP structure were separately tested for swelling. A polyvinyl alcohol (PVA)-boehmite layer of approximately 16 micron thickness, made according to the fourth paragraph of Example 1 of U.S. Pat. No. 8,883,354 to Carlson, et al., with 11 parts of ethylene carbonate, 6 parts of the divinyl ether of triethylene glycol (DVE-3), and 3 parts of polyethylene oxide (molecular weight of 200), served as the non-swelling layer that was laminated between two CSP-B2 layers of approximately 11 microns in thickness.

The resulting properties of the laminate are summarized in Table 10 below.

TABLE 10

| Property | Value mean (2 sigma) | |
|---|---|---|
| thickness | 39.1 (0.6) | microns |
| maximum tensile load | 0.868 (0.084) | kg |
| maximum tensile stress | 1659 (145) | psi |
| elongation @ break | 2.6 (3.0) | % |
| Gurley permeability* | 794 (52) sec/100 cc | |
| solvent swelling ** | 0.24 (0.21) | % |

*normalized to 20 microns
** propylene carbonate/5 minute and 60 minute imbibitions/soaking

As shown in Table 10 above, the laminate showed less than 0.5% swelling in propylene carbonate after soaking for 1 hour, thus confirming the effectiveness of laminating solvent-swellable, but strong and flexible and very stable and safe in lithium ion batteries at high temperature, versions of CSP to a non-swellable, but low in elongation, layer to yield low net swelling. The samples exhibited a net reduction in tensile strength relative to CSP-B2 separators and a reduction in elongation/ductility, but this can be improved by adjustments for better elongation/ductility in the composition of non-swellable layers to better match the higher elongation before break of the solvent-swellable and high safety versions of CSP, such as those described herein for CSP-A, CSP—B, CSP-B2, and CSP-B3 with their flame retardant PVdF polymer binder. The net effect on the Gurley permeability number was negligible (once normalized to 20 microns).

### Example 24

Samples of separators formed in conformance with the CSP-B and CSP-B2 blend proportions were evaluated against samples that were formed with the CSP-A coating mixture blend proportions.

FIG. 33A is a diagram showing the maximum tensile strength (psi) results on samples of the three (3) separator versions, CSP-A, CSP-B, and CSP-B2. As shown in FIG. 33A, the CSP-B2 samples provided increased mechanical strength at 2000 psi of about 10% compared to CSP-A, despite using less binder (3.75:1 P:B for CSP-B2 vs. 3.5:1 for CSP-A), while exhibiting an acceptable tradeoff against the CSP-B version in light of a balance of other properties as detailed in the following.

FIG. 33B is a diagram showing the percentage (%) elongation at break for the samples of the three (3) separator versions, CSP-A, CSP-B, and CSP-B2. As shown in FIG. 33B, the CSP-B2 samples showed slightly lower elongation of about 25% compared to CSP-A with elongation of about 30%.

FIGS. 33C and 33D respectively show the Gurley air permeability number and separator impedance for the samples of the three (3) separator versions, CSP-A, CSP-B, and CSP-B2.

While maintaining very similar mechanical strength to the CSP-B separator, the CSP-B2 separators showed a significant reduction in the Gurley air permeability number to about 550 seconds/100 cc compared to 1050 seconds/100 cc for CSP-A and about 900 seconds/100 cc for CSP-B. While the CSP-B separators showed substantial improvements in mechanical strength compared to CSP-A, as reflected in FIGS. 33A and 33B above, they exhibited higher impedance, as shown in FIG. 33D, despite having a slightly lower Gurley air permeability number. Accordingly the CSP-B2 samples provided the desirable improvement in lowering separator impedance by about 25% from that of CSP-A, with a far greater reduction in Gurley values (FIG. 33C), while maintaining acceptable mechanical properties.

FIG. 33E shows the linear dimensional change (swelling properties) of the samples of the 3 separator versions, CSP-A, CSP-B, and CSP-B2. As shown in FIG. 33E, the CSP-B samples exhibited a significant reduction in separator swelling to about 3.3% in propylene carbonate compared to CSP-A with a % swelling of about 6.5%. Correspondingly, the CSP-B2 version with an even larger pore size and less PVdF binder yielded a further improvement with slightly lower swelling at about 3.0% compared to CSP-B.

As shown above, the CSP-B2 blend yielded separators with improved mechanical strength at approximately 2,000 psi, while significantly lowering the Gurley values, separator impedance, and swelling properties over the CSP-A separators. A summary of the results is further provided in Table 11 below.

TABLE 11

| | | Mechanical | |
|---|---|---|---|
| | Deformation | strength | |
| | (swelling) | enhancement | Separator |
| | reduction | (psi) | impedance |
| CSP-A | 6.5% | 1500 | 2.8 |
| CSP-B | 3.3% | 2065 | 4.5 |
| CSP-B2 | 3.0% | 2000 | 2.3 |

XII. Extraction

As described above, one or more ceramic components in a coating mix blend may be surface treated—with, for example, p-toluene sulfonic acid—to facilitate dispersion in organic solvents instead of using dispersants, which may present low molecular weight species and potentially migratory components that may degrade the cell performance. Furthermore, as described above, applying a cross-linker is one of a number of options for further enhancement of CSP mechanical properties and/or electrochemical performance—in other words, adding low molecular weight additives that may not be fully “bound” via chemical bonding to the primary separator components (such as boehmite and PVdF binder).

As further described above, Desmodur® RE is an example of a cross-linker that showed, in testing, improved mechanical properties at loading levels of ˜1%-6% w/w of PVdF polymer binder (i.e., very low overall loadings) in CSP separators. For this example, the resultant separator coatings have a distinct pink-purple color (depending on loading of the cross-linker, and exposure to light). One cause for concern is the fact that this distinct color is readily leached from the separator when exposed to electrolyte solvents. Accordingly, extraction testing was performed to confirm a preservation of positive mechanical properties through solvent exposure.

### Example 25

Extraction of modified CSP-A dry separators (D10SR/D10F4 50:50, S5140, 2% RE) using an aqueous alcohol solution was performed in a water/IPA (isopropyl alcohol) (50:50) bath over 60 minutes. The extracted and control samples were subsequently dried at 100° C. for 60 minutes.

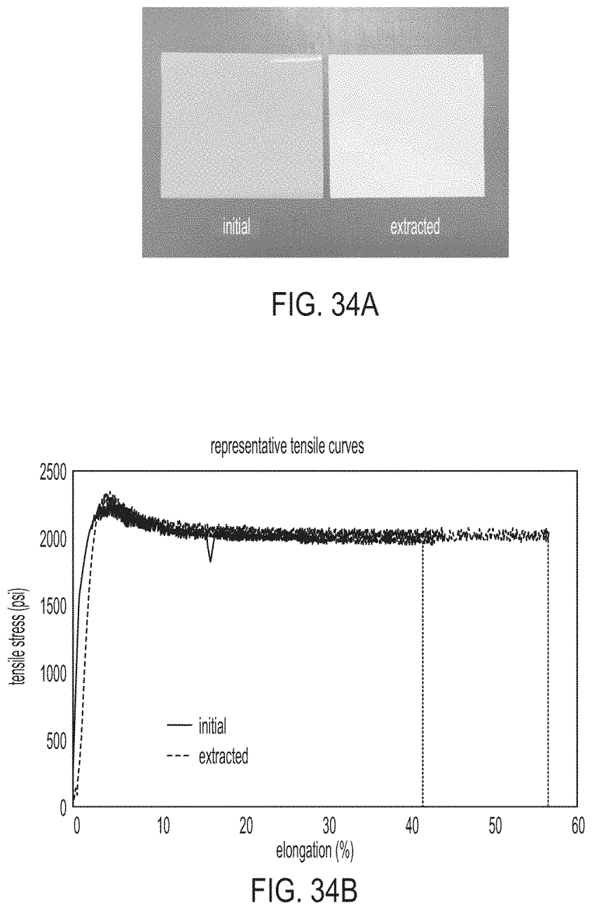

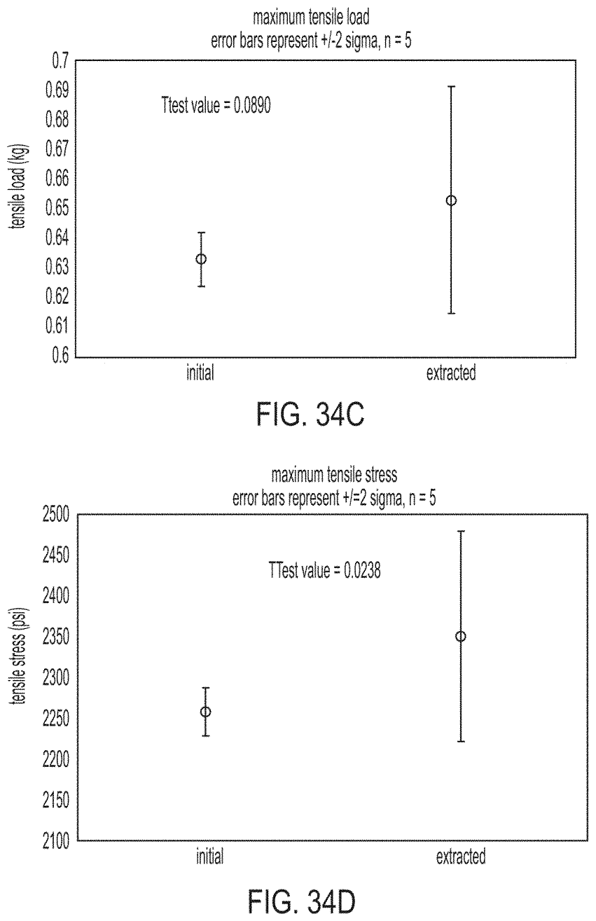

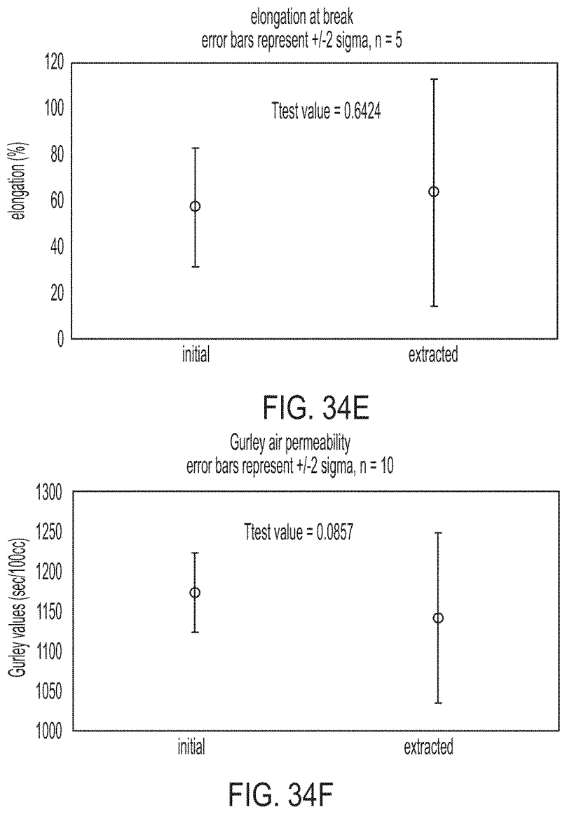

FIG. 34A is a photograph illustrating the different coloration between a cross-linked “initial” sample and an “extracted” sample, showing that water/alcohol extraction removes most “color” from RE-modified CSP coatings.

FIG. 34B is a graph of representative tensile curves of the respective samples, which reflect a slight tensile strength improvement with extraction. The results are confirmed by the maximum tensile loads and maximum tensile stresses shown in FIGS. 34C and 34D.

As shown in FIG. 34E, elongation/ductility remained unchanged after extraction and, as shown in FIG. 34F, Gurley values showed a slight but statistically significant drop.

In summary, provided are free-standing CSP separators with improved safety, heat stability, and thermal conductivity properties compared to CCS separators. The added heat stability of the CSP of this invention enables high temperature vacuum drying, such as at 130° C. to 150° C., of CSP, of cell stacks of electrodes with CSP, and of dry cells with CSP, that are not possible with CCS. This high temperature vacuum drying results in improved cell cycle life, rate capability, and cell storage stability. Very importantly, CSP shows superior safety results compared to CCS when tested in cells by ARC and nail penetration testing methods.

The free-standing CSP separators of this invention have improved performance over prior CSP separators, particularly in higher mechanical strength while providing excellent elongation/ductility and higher ionic conductivity and rate capability. A number of process and materials options to obtain the improved performance for the CSP separators of this invention are described herein, including, but not limited to, the use of particular blends of ceramic particles and the mix and filtration processes for the CSP coating with these blends, the use of functionalized PVdF, such as Solef® 5130 and Solef® 5140, with preferred functionality and molecular weight, the use of different non-swelling porous layers to reduce the swelling of the CSP in the electrolyte, vacuum drying at high temperatures for both CSP and for dry cells with CSP, the use of edge reinforcement materials on the slit edges, the use of cross-linkers in the CSP layer, the use of a calendering process on the CSP, the use of solvent/water extraction to remove soluble materials, the addition of a shutdown layer, and combinations of the foregoing.

Now that embodiments of the present invention have been shown and described in detail, various modifications and improvements thereon will become readily apparent to those skilled in the art. Accordingly, the spirit and scope of the present invention is to be construed or broadly and not limited by the foregoing specification

1-17. (canceled)

18. A lithium cell comprising:
an anode,
a cathode,
an organic electrolyte comprising a lithium salt, and
a separator interposed between said anode and said cathode, wherein said separator comprises a first porous layer comprising:
(i) 60 to 95% by weight of particles selected from the group consisting of inorganic oxides and inorganic nitrides; and
(ii) a first organic polymer binder;
wherein said separator:
(i) has a tensile stress of at least 1700 psi and an elongation at break of 15%;
(ii) has a Gurley air permeability number of 600 seconds/100 cc or less when the thickness of said separator is normalized to 20 microns; and
(iii) does not include a polymer separator layer.

19. The lithium cell of claim 18, wherein said lithium cell shuts down at a temperature of at least 110° C.

20. The lithium cell of claim 18, wherein said lithium cell has a capacity of 5 Ah or higher and has no cell voltage drop until a temperature of at least 190° C. when tested with an accelerating rate calorimeter (ARC) in a “Heat-Wait-Search” mode in an adiabatic environment.

21. The lithium cell of claim 18, wherein said lithium cell has a capacity of 3.5 Ah or higher and the temperature measured at the surface of the lithium cell at 100% state of charge does not exceed 100° C. when a 3 mm diameter nail penetrates the cell at a speed of about 8 cm/sec.

22. The lithium cell of claim 18, wherein said lithium cell has a capacity of 3.5 Ah or higher and the temperature measured at the surface of the lithium cell at 100% state of charge does not exceed 70° C. when a 3 mm nail penetrates the cell at a speed of about 8 c/sec.

23. The lithium cell of claim 18, wherein said lithium cell has a cycle life at 25° C. of 3,000 cycles or longer with at least an 80% capacity retention when cycled at 1 C charge and 1 C discharge rates at 100% Depth of Discharge (DoD).

24. The lithium cell of claim 18, wherein the first porous layer comprises a cross-linker.

25. The lithium cell of claim 18, wherein said separator has a shrinkage of less than 1% when heated at 200° C. for 1 hour.

26. The lithium cell of claim 18, wherein the inorganic oxides in said first porous layer comprise boehmite particles.

27. The lithium cell of claim 26, wherein said boehmite particles are hydrophobically-modified boehmite particles.

28. The lithium cell of claim 18, further comprising:
an edge reinforcement lane on one or more edges of said separator,
wherein said edge reinforcement lane is selected from the group consisting of a compression lane, an edge reinforcement coating lane, and a combination of a compression lane and an edge reinforcement coating lane.

29. The lithium cell of claim 18, wherein the first porous layer comprises a polyvinylidene fluoride polymer.

30. The lithium cell of claim 18, wherein said separator has less than 5.0% swelling when soaked in propylene carbonate for 1 hour.

31. The lithium cell of claim 1, wherein said separator has a tensile stress of at least 2000 psi.

32. The lithium cell of claim 1, wherein said separator has a Gurley air permeability number of less than 300 seconds/100 cc when the thickness of said separator is normalized to 20 microns.

33. The lithium cell of claim 1, wherein said separator comprises a second porous layer comprising a second organic polymer binder.

34. The lithium cell of claim 16, wherein said second organic polymer binder comprises thermally fusible particles.

35. The lithium cell of claim 16, wherein said thermally fusible particles comprise polymer particles.

36. A lithium cell comprising:
an anode,
a cathode,
an organic electrolyte comprising a lithium salt and a flammable organic solvent; and
and a porous free-standing inorganic/organic composite separator that does not comprise a porous plastic substrate,
wherein said lithium cell
has a capacity of about 3.5 Ah or higher, and
the temperature measured at the surface of the lithium cell at a 100% state of charge does not exceed 100° C. when a 3 mm diameter nail penetrates the cell at a speed of about 8 cm/sec.

37. The lithium cell of claim 36, wherein the temperature measured at the surface of the lithium cell at a 100% state of charge does not exceed 70° C. when a 3 mm diameter nail penetrates the cell at a speed of about 8 cm/sec.

38. The lithium cell of claim 36, wherein said flammable organic solvent is an organic carbonate.

39. A lithium cell comprising:
an anode;
a cathode;
an organic electrolyte comprising a lithium salt and a flammable organic solvent; and
a porous free-standing inorganic/organic composite separator that does not comprise a porous plastic substrate,
wherein said lithium cell has a capacity of 5 Ah or higher and has no self-heating onset until a temperature of at least 150° C. when tested with an accelerating rate calorimeter (ARC) in a “Heat-Wait-Search” mode in an adiabatic environment.

40. The lithium cell of claim 39, wherein said flammable organic solvent is an organic carbonate.

41. The lithium cell of claim 39, wherein said lithium cell maintains operation at 150° C. over a period of at least 3 hours when heated to that temperature in said accelerating rate calorimeter (ARC) test.

42. The lithium cell of claim 39, wherein said lithium battery shuts down at a temperature of at least 150° C.
